(19) United States
(12) Patent Application Publication
(10) Pub. No.: US 2011/0049057 A1
(43) Pub. Date: Mar. 3, 2011

(54) Metal Immobilization Using Slag Fines

(76) Inventors: Dennis G. GRUBB, Lansdale, PA (US); Mahmoud Wazne, New York, NY (US)

(21) Appl. No.: 12/874,079

(22) Filed: Sep. 1, 2010

Related U.S. Application Data
(60) Provisional application No. 61/307,231, filed on Feb. 23, 2010.
(60) Provisional application No. 61/239,285, filed on Sep. 2, 2009.

(51) Int. Cl. C02F 1/62; A62D 3/30; A62D 3/37; A62D 3/38; B01J 20/02; C02F 1/58; B01D 39/06

(52) U.S. Cl. 210/682; 588/313; 588/319; 588/320; 502/406; 210/681; 210/683; 210/688; 210/502.1

(57) ABSTRACT

A method for immobilizing metal in soil includes blending slag fines with soil to form a media. The slag fines immobilize metal present in the media and reduce leaching of the metal into water.

### CROSS REFERENCE TO RELATED APPLICATIONS

This application claims the benefit of U.S. Appl. No. 61/239,285, filed on Sep. 2, 2009 and of U.S. Appl. No. 61/307,231, filed on Feb. 23, 2010, both of which are hereby incorporated by reference in their entirety.

### BACKGROUND OF THE INVENTION

1. Field of the Invention

The present invention relates to metals immobilization media and methods for immobilizing heavy or toxic metals (for example As(III), As(V), Cd, Cu, P, Pb, Ni, W, Se(IV), Se(VI), and Zn), in particular with the use of slag fines.

2. Background Art

Environmental remediation is an ongoing concern as our waterways and soils become contaminated with metals and metal alloys. Leaching of metals and metal alloys from contaminated soils or soil-like media into ground water is one particular concern. Options exist for preventing metals present in contaminated soils or soil-like media from leaching into groundwater and for removing or reducing the concentrations of metals present in contaminated water, however there is a continuing need for innovative ways to accomplish environmental remediation.

### BRIEF SUMMARY OF THE INVENTION

Metals immobilization using slag fines, such as basic oxygen furnace (BOF) slag fines, also known as steel slag fines (SSF), or blast furnace slag fines (BFF) is an innovative use for slag fines. Slag fines may be a granular media that may correspond to a ⅜ inch minus material, with typically less than 20% by weight passing through a U.S. No. 200 sieve (0.075 mm), though shifts in the gradation to somewhat larger or finer gradations should perform similarly. Slag fines can contain Fe(0) and are geochemically active. Slag fines may immobilize both cationic and oxyanionic heavy metals from aqueous, soils, and soil-like media. The slag fines may immobilize the metals by sorption, precipitation, complexation, oxidation and reduction processes, pH controlled processes, or combinations thereof, without the need for additives. The use of slag fines in environmental remediation is particularly advantageous because it can be potentially accomplished with low cost industrial byproducts and recycled materials.

In some embodiments, slag fines may be used as a firing range soil and/or firing range backstop berm, either alone or in combination with other soils and soil-like media, into which bullets or projectiles are directly fired. The leaching of metals from such slag fine berms is significantly lowered over conventional granular media (i.e., sands, gravels, natural soils) as a result of the metals immobilizing characteristics of the slag fines.

In some embodiments, slag fines may be used as a filter medium (e.g., layer, mat, canister, trench, chimney, reactive subbase, trickling filter) through which heavy metals laden water (mine, surface, ground, leachate or process) flows. The slag fines may partially reduce or wholly eliminate the aqueous phase concentrations of the metals.

In some embodiments, slag fines may be directly blended with heavy metals laden soils and soil-like media (residues, dusts, powders, filter cakes, dredged material, fly ash or other ash materials, sludges, quarry fines, mine spoil, etc.) to simultaneously provide geotechnical enhancements to the soils and soil-like media (e.g., strength, drainage, and/or reduced settlement) while also immobilizing the heavy metals in the soils and soil-like media, and/or water present in pores of the soils and soil-like media, or waters that may eventually pass through the combined media.

In some embodiments, the present invention is directed to a method for immobilizing heavy metals in soil, comprising blending slag fines with soil to form a media, wherein the slag fines contain Fe(0), are geochemically active, immobilize metal present in the media and reduce leaching of the metal into water.

In some embodiments, the slag fines are steel slag fines, blast furnace slag fines, or combinations thereof.

In some embodiments, the slag fines are bordered by, enclosed by, layered with, or prefabricated with a geosynthetic.

In some embodiments, the metal immobilized by the slag fines is a cationic metal, an oxyanionic metal, or alloys thereof. In some embodiments, the cationic metal is selected from the group consisting of cadmium, copper, lead, nickel, zinc, and alloys thereof. In some embodiments, the oxyanionic metal is selected from the group consisting of arsenic, phosphorus, selenium, tungsten, uranium, and alloys thereof. In some embodiments, the metal immobilized by the slag fines is selected from the group consisting of lead, copper, cadmium, zinc, arsenic, selenium, tungsten, uranium, nickel, phosphorus, and alloys thereof.

In some embodiments, the slag fines immobilize the metal through a process selected from the group consisting of sorption, precipitation, complexation, pH controlled processes, oxidation and reduction processes, and combinations thereof.

In some embodiments, the soil comprises soil-like media. In some embodiments, the soil-like media is selected from the group consisting of residue, dust, powder, filter cake, dredged material, ash materials, sludge, quarry fines, mine spoil, and combinations thereof.

In some embodiments, the method further comprises making a berm or berm system for a firing range comprising the media.

In some embodiments, the method further comprises applying a ground covering at a firing range with the media.

In some embodiments, the method further comprises making a geotechnical fill comprising the media. In some embodiments, the geotechnical fill is usable for applications selected from the group consisting of earthwork construction, land reclamation, mine reclamation, brownfields redevelopment, and portfields redevelopment.

In some embodiments, the present invention is directed to a metal immobilization media comprising a blend of slag fines and soil, wherein the slag fines contain Fe(0), are geochemically active, immobilize a metal present in the media, and reduce leaching of the metal into water.

In some embodiments, the slag fines are steel slag fines, blast furnace slag fines, or combinations thereof.

In some embodiments, the slag fines are bordered by, enclosed by, layered with, or prefabricated with a geosynthetic.

In some embodiments, the slag fines are capable of immobilizing a cationic metal, an oxyanionic metal, or alloys thereof. In some embodiments, the cationic metal is selected from the group consisting of cadmium, copper, lead, nickel, zinc, and alloys thereof. In some embodiments, the oxyanionic metal is selected from the group consisting of arsenic, phosphorus, selenium, tungsten, uranium, and alloys thereof. In some embodiments, the slag fines are capable of immobilizing metal selected from the group consisting of lead, copper, cadmium, zinc, arsenic, selenium, tungsten, uranium, nickel, phosphorus and alloys thereof.

In some embodiments, the soil comprises soil-like media. In some embodiments, the soil-like media is selected from the group consisting of residue, dust, powder, filter cake, dredged material, ash material, sludge, quarry fines, mine spoil, and combinations thereof.

In some embodiments, the media is a berm for a firing range.

In some embodiments, the media is a ground covering at a firing range.

In some embodiments, the media is a geotechnical fill. In some embodiments, the geotechnical fill is capable for use in applications selected from the group consisting of earthwork construction, land reclamation, mine reclamation, brownfields redevelopment, and portfields redevelopment.

In some embodiments, the present invention is directed to a method of filtering water, comprising placing a filter comprising a blend of slag fines in a flow path of water, wherein the slag fines immobilize a metal present in the water to reduce an aqueous phase concentration of the metal in the water and the slag fines contain Fe(0) and are geochemically active.

In some embodiments, the slag fines are steel slag fines, blast furnace slag fines, or combinations thereof.

In some embodiments, the slag fines are bordered by, enclosed by, layered with, or prefabricated with a geosynthetic.

In some embodiments, the metal immobilized by the slag fines is a cationic metals, an oxyanionic metal, or alloys thereof. In some embodiments, the cationic metal is selected from the group consisting of cadmium, copper, lead, nickel, zinc, and alloys thereof. In some embodiments, the oxyanionic metal is selected from the group consisting of arsenic, phosphorus, selenium, tungsten, uranium, and alloys thereof. In some embodiments, the metal immobilized by the slag fines is selected from the group consisting of lead, copper, cadmium, zinc, arsenic, selenium, tungsten, uranium, nickel, phosphorus, and alloys thereof.

In some embodiments, the present invention is directed to a metal immobilization filter, comprising a blend of slag fines, wherein the slag fines are capable of immobilizing a metal present in a water passing through the filter to reduce an aqueous phase concentration of the metal in the water and the slag fines are geochemically active and contain Fe(0).

In some embodiments, the slag fines are steel slag fines, blast furnace slag fines, or combinations thereof.

In some embodiments, the filter further comprises a geotextile bordering, enclosing, layered with, or prefabricated with a layer of the slag fines.

In some embodiments, the slag fines are capable of immobilizing a cationic metal, an oxyanionic metal, or alloys thereof. In some embodiments, the cationic metal is selected from the group consisting of cadmium, copper, lead, nickel, zinc, and alloys thereof. In some embodiments, the oxyanionic metal is selected from the group consisting of arsenic, phosphorus, selenium, tungsten, uranium, and alloys thereof. In some embodiments, the slag fines are capable of immobilizing metal selected from the group consisting of lead, copper, cadmium, zinc, arsenic, selenium, tungsten, uranium, nickel, phosphorus, and alloys thereof.

### BRIEF DESCRIPTION OF THE DRAWINGS/FIGURES

The accompanying drawings, which are incorporated herein and form a part of the specification, illustrate the present invention by way of example, and not by way of limitation. The drawings together with the description, further serve to explain the principles of the invention and to enable a person skilled in the pertinent art to make and use the invention.

FIG. 1 is a table illustrating the bulk chemistry of steel slag fines, blast furnace slag fines, and dredged material.

FIG. 2 is a table illustrating the total concentrations of metals in steel slag fines (SSF).

FIG. 3 is a table illustrating the total concentrations of metals in blast furnace slag fines (BFF).

FIG. 4 is a chart illustrating a lead solubility curve as a function of pH.

FIG. 5 is a table illustrating the total concentrations of metals in dredged material (DM).

FIG. 6 is a graph showing the removal rate of As(III).

FIG. 7 is a graph showing the removal rate of As(V).

FIG. 8 is a graph showing the removal rate of Cd(II).

FIG. 9 is a graph showing the removal rate of Cu(II).

FIG. 10 is a graph showing the removal rate of Ni(II).

FIG. 11 is a graph showing the removal rate of Pb(II).

FIG. 12 is a graph showing the removal rate of W(VI).

FIG. 13 is a graph showing the removal rate of Zn(II).

FIG. 14 is a table illustrating the concentrations of arsenic, chromium and iron in arsenic spiked steel slag fines and blast furnace slag fines.

FIG. 15 is a table illustrating the leached concentrations of arsenic, chromium and iron from arsenic spiked steel slag fines and blast furnace slag fines after performing TCLP.

FIG. 16 is a table illustrating the leached concentrations of arsenic, chromium and iron from arsenic spiked steel slag fines and blast furnace slag fines after performing SPLP.

FIG. 17 is a graph showing the acid neutralization capacity of dredged material, steel slag fines and blast furnace slag fines, including milled slag fines.

FIG. 18 is a graph showing the acid neutralization capacity of blends of dredged material and steel slag fines.

FIG. 19 is a graph showing the acid neutralization capacity and leached arsenic concentrations from dredged material and steel slag fines.

FIG. 20 is a graph showing the acid neutralization capacity and leached chromium concentrations from dredged material and steel slag fines.

FIG. 21 is a graph showing the acid neutralization capacity and leached iron concentrations from dredged material and steel slag fines.

FIG. 22 is a graph showing the acid neutralization capacity (ANC) behavior of steel slag fines.

FIG. 23 is a graph showing the ANC-derived metal concentration for As(III).

FIG. 24 is a graph showing the ANC-derived metal concentration for As(V).

FIG. 25 is a graph showing the ANC-derived metal concentration for Cd(II).

FIG. 26 is a graph showing the ANC-derived metal concentration for Cu(II).

FIG. 27 is a graph showing the ANC-derived metal concentration for Ni(II).

FIG. 28 is a graph showing the ANC-derived metal concentration for Pb(II).

FIG. 29 is a graph showing the ANC-derived metal concentration for W(VI).

FIG. 30 is a graph showing the ANC-derived metal concentration for Zn(II).

FIG. 31 is a graph showing the ANC-derived metal concentration for Ca.

FIG. 32 is a graph showing the ANC-derived metal concentration for Fe.

FIG. 33 is a graph showing the ANC-derived metal concentration for Mg.

FIG. 34 contains standard proctor compaction curves for dredged material-steel slag fines blends and dredged material-blast furnace slag fines blends.

FIG. 35 contains modified proctor compaction curves for dredged material-steel slag fines blends and dredged material-blast furnace slag fines blends.

FIG. 36 is a table illustrating the totals concentrations of metals leached from dredged material utilizing TCLP and SPLP.

FIG. 37 is a table illustrating the concentrations of metals leached from steel slag fines and blast furnace slag fines utilizing TCLP and SPLP.

FIG. 38 is a table illustrating totals and leached concentrations of arsenic in dredged material, steel slag fines, and steel slag fines blended with and without arsenite and arsenate spiked dredged material.

FIG. 39 is a table illustrating the total concentrations of arsenic for 100 mg/kg arsenite-spiked dredged material individually blended with steel slag fines and blast furnace slag fines and up to two percent NewCem (NC) slag cement.

FIG. 40 is a table illustrating the TCLP leached concentrations of arsenic for 100 mg/kg arsenite-spiked dredged material individually blended with steel slag fines and blast furnace slag fines and up to two percent NewCem (NC) slag cement.

FIG. 41 is a table illustrating the SPLP leached concentrations of arsenic for 100 mg/kg arsenite-spiked dredged material individually blended with steel slag fines and blast furnace slag fines and up to two percent NewCem (NC) slag cement.

FIG. 42 is a table illustrating the total concentrations of arsenic for 100 mg/kg arsenate-spiked dredged material individually blended with steel slag fines and blast furnace slag fines and up to two percent NewCem (NC) slag cement.

FIG. 43 is a table illustrating TCLP leached concentrations of arsenic for 100 mg/kg arsenate-spiked dredged material individually blended with steel slag fines and blast furnace slag fines and up to two percent NewCem (NC) slag cement.

FIG. 44 is a table illustrating SPLP leached concentrations of arsenic for 100 mg/kg arsenate-spiked dredged material individually blended with steel slag fines and blast furnace slag fines and up to two percent NewCem (NC) slag cement.

FIG. 45 is a graph illustrating the swell behavior of blends of dredged material and steel slag fines.

FIG. 46 is a graph illustrating the swell behavior of blends of dredged material and blast furnace slag fines.

### DETAILED DESCRIPTION OF THE INVENTION

A process of immobilizing metals in a variety of sources, such as aqueous bodies, soils, and soil-like media may include providing a metals immobilization media that immobilizes and limits the mass transfer of the metals present in these sources. A metal immobilization media may include slag fines such as basic oxygen furnace slag fines, also known as steel slag fines, or blast furnace slag fines.

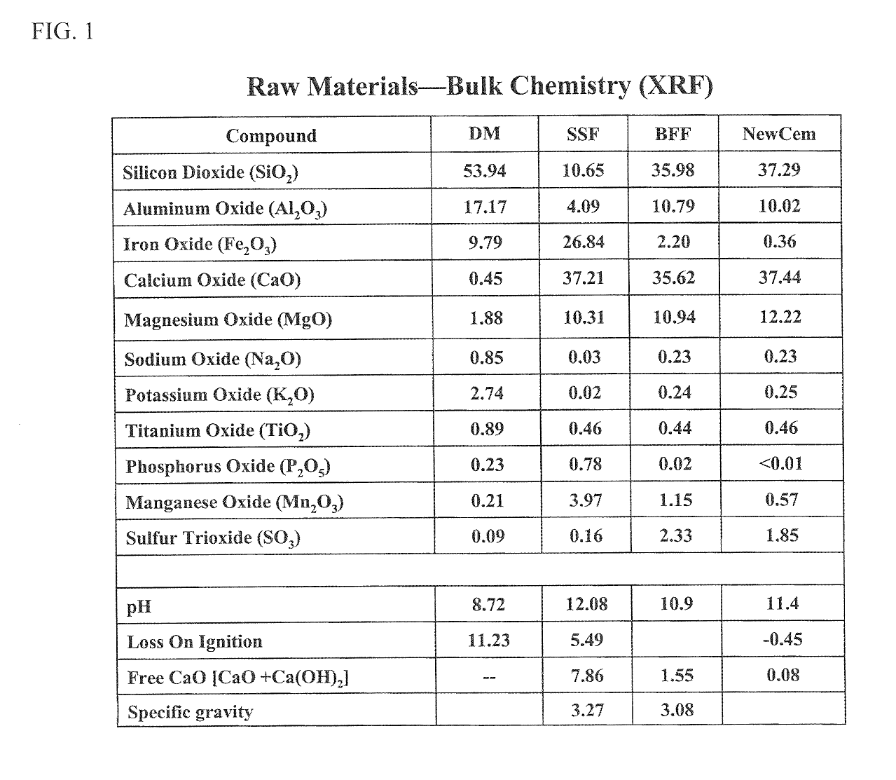

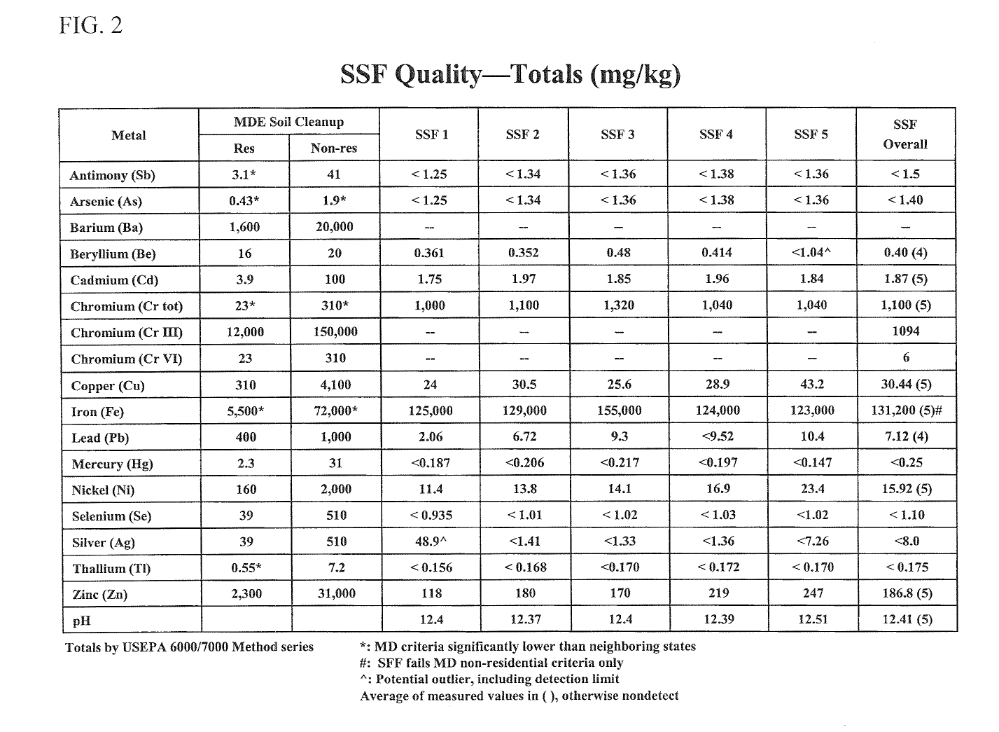

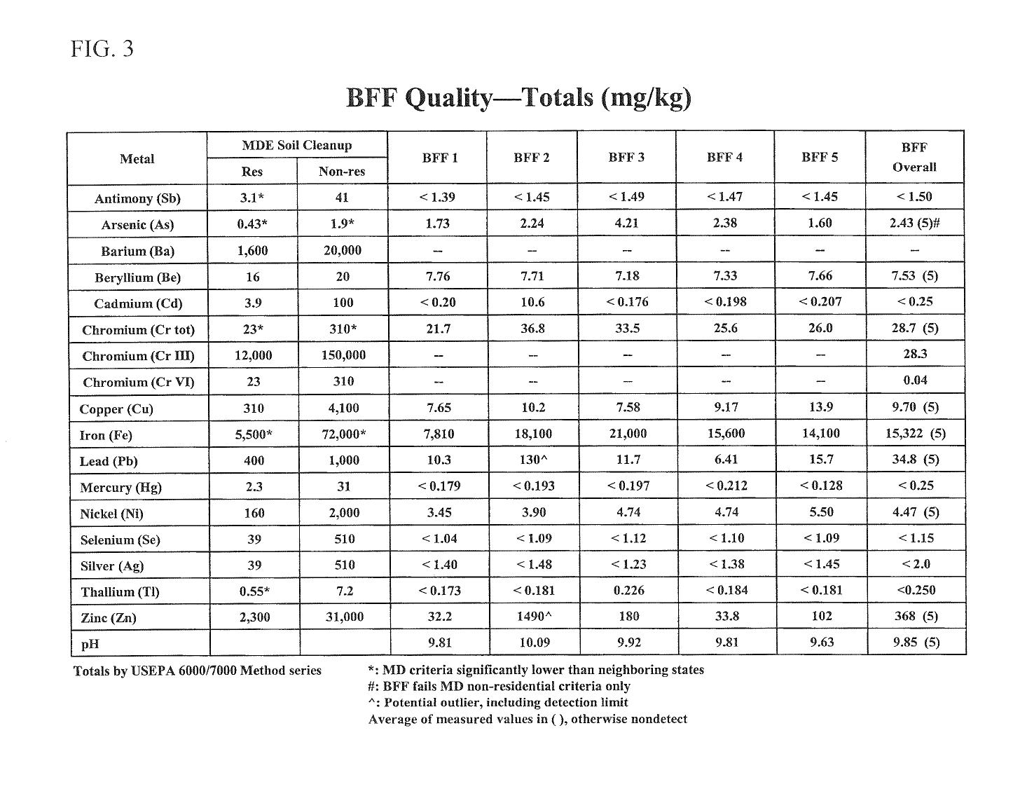

Slag is a collection of molten byproducts exiting a furnace during a steel making or metals purification process. As their name suggests, basic oxygen furnace (BOF) slag fines (or steel slag fines) originate from a basic oxygen furnace during the steel-making process. Similarly, blast furnace slag fines may originate from a blast furnace during a steel-making process. Other slags, such as argon oxygen decarburization (AOD) slag, can possess a reactive geochemistry which allows them to be similarly used for metals immobilization. Slag may be recycled, for example, by air cooling followed by crushing and screening processes, as a synthetic construction aggregate for roadway and civil construction. Slag fines are the residual material from such crushing and screening processes and are a granular material. In some embodiments, the slag fines may have a grain size on the order of ⅜ inch minus with less than 20% by weight passing through a U.S. No. 200 sieve (0.075 mm), although somewhat coarser grain sizes are likely to provide similar functions. Also, slag fines may be milled to smaller sizes which may to increase their sorption and buffering capacity. The bulk chemistry in terms of weight percentage of one source of steel slag fines (SSF) and blast furnace slag fines (BFF) is shown for illustrative purposes in FIG. 1 as measured by x-ray fluorescence (XRF). FIGS. 2 and 3 provide the total concentrations of select metals from additional samples of the SSF and BFF media.

On their own, slag fines may immobilize both cationic and oxyanionic heavy metals and metal alloys present in aqueous, soils, and soil-like media. Exemplary cationic heavy metals that may be immobilized by slag fines may include, but are not limited to, lead, copper, cadmium, nickel and zinc. Exemplary oxyanionic heavy metals that may be immobilized by slag fines may include, but are not limited to, arsenic, phosphorus (as phosphate), selenium, tungsten, and uranium. The slag fines may immobilize the metals by sorption, precipitation, complexation, oxidation and reduction processes, pH controlled processes, or combinations thereof, without the need for additives. Slag fines have sufficient immobilization properties on their own, however, other reagents may also be added to the slag fines such as lime, cementitous materials or salts to facilitate the immobilization. Inert media may also be added as a filler to influence the blend properties. In some embodiments, a metals immobilization media may include slag fines when cationic metals immobilization is a primary concern. In some embodiments, a metals immobilization media may include slag fines when oxyanionic metals immobilization is a primary concern.

The bulk chemistry of iron (Fe) shown in FIG. 1 for the BFF and SSF media (or other slag media) may be further speciated as Fe(0), Fe(II) and Fe(III) directly in the solid phase using X-ray absorption near edge spectroscopy (XANES) and by various refinements of this spectroscopic approach.

In order to perform the XANES analyses, duplicate samples of the SSF and BFF media were first pulverized using a Fritsch Planetary Ball Mill. Approximately 10 g of the air-dried sample was placed into milling containers and was pulverized for 20 minutes at a rotation speed of about 250 RPM. The entire pulverized sample was passed through 100 sieve (0.15 mm) to avoid any fractionation. Three iron standards were used as reference for the quantification of Fe. The reference standards for Fe(0), Fe(II) and Fe(III) were nano zerovalent iron (synthesized in laboratory), ferrous sulphate heptahydrate (FeSO₄.7H₂O, 99% purity, Fisher Scientific, GA, USA) and ferric chloride hexahydrate (FeCl₃.6H₂O, 98% purity, Fisher Scientific, GA, USA), respectively.

XANES analyses were performed at the Pohang Accelerator Laboratory (PAL) in the Republic of Korea using a beam line 7C (Electrochemistry) with a Si(111) monochromator and ring current of about 120-170 mA at about 2.5 GeV. The Fe K-edge XANES spectra were collected in both transmission and fluorescence modes over the range from about 100 eV below the Fe K-edge at about 7,112 eV to as much as about 900 eV above the edge. In order to remove the energy shift problem, energy calibration was carried out by measuring the XANES spectra of Fe foil (99.99% purity, Exafs Materials, Inc., CA, USA) and the samples simultaneously. Quantitative XANES analyses were conducted using the ATHENA program in the IFEFFIT computer package.

Table 1 summarizes the quantitative XANES results of Fe(0), Fe(II) and Fe(III) in the slag fines, where the total concentrations of iron in the SSF and BFF media were taken to be 131,200 mg/kg and 15,322 mg/kg, respectively, based on the averaged data shown in FIGS. 2 and 3. The average iron distribution in each media is also shown as a percentage in Table 1.

TABLE 1
Quantitative XANES analyses for BFF and SSF Media

XANES

| | Total Fe | Fe(0) | Fe(II) | Fe(III) |
|---|---|---|---|---|
| Media | (mg/kg) | (mg/kg) | (mg/kg) | (mg/kg) |
| BFF | 15,322 | 1,846 | 2,543 | 10,932 |
| | | (12.1%) | (16.6%) | (71.4%) |
| SSF | 131,200 | 16,662 | 60,942 | 53,661 |
| | | (12.7%) | (46.5%) | (40.9%) |

* Numbers shown in parenthesis denote percentages of total.

Zero-valent iron [Fe(0)] has been used to reduce oxidized forms of heavy metals, including oxyanions such as chromate, selenate, uranyl, etc., and halogenated organic compounds such as TCE, etc., with variable levels of efficiency. In some embodiments, the present invention utilizes SSF, BFF, or other slag fines that contain Fe(0) and that are geochemically active. In some embodiments, the present invention utilizes slag fines wherein at least 1%, at least 5%, at least 10% or at least 15% by weight of the iron present in the slag fines is Fe(0). In some embodiments, the present invention utilizes slag fines wherein 1% to 15%, 1% to 10%, 1% to 5%, 5% to 15%, 5% to 10%, or 10% to 15% by weight of the iron present in the slag fines is Fe(0).

SSF and BFF media are an under-utilized resource for environmental remediation. The unexpected metals immobilizing properties and high buffering capacity of these slag fines (and others) make slag fines ideal component in a metals immobilization media. For example, slag fines may be used alone or in combination with other materials as a metals immobilization media for using in firing ranges as a backstop berm or other range media, as a filtering medium, and as a geotechnical fill material, as will be described in more detail below. In any of these applications, the slag media can be bordered by, enclosed by, layered with and/or prefabricated with geosynthetics (e.g., geotextiles) to enhance the strength, drainage, flow, particle separation and metals immobilization of the slag containing system.

### Firing Range Berm

In one embodiment, slag fines of a quality similar to that shown in FIGS. 1-3 and 37 may be used as a firing range soil media and/or firing range backstop berm or berm system (including its attendent runoff, drainage and water conveyance systems) either alone or in combination with other soils and soil-like media into which bullets or projectiles are directly fired. The leaching of metals from such slag fine berms is significantly lowered over conventional granular media (e.g., sands, gravels, natural soils). The slag materials (of even a coarser gradation) can also be used as a “reactive” subbase material or “beaching” media upon which excess molten Pb, Cu or other industrial metals can be poured and air-cooled during the metals refining, smelting and foundry processes. Such uses of slag media would mitigate heavy metals contamination of soils and groundwater.

Most firing ranges utilize soil impact berms behind the target line to stop bullets from leaving the firing range. These impact berms are usually constructed of mixtures of sand, silt, and clay soils. These soils have very little sorption and immobilization potential for heavy metals, and they must be routinely sieved to remove bullet fragments and/or be changed out. The use of a metals immobilization media such as slag fines in firing range applications as a substitute for the gravelly/sandy/clayey soils currently used as backstop media may prevent or minimize undesirable leaching of metals into the subsurface, surface waters and/or groundwater.

Firing range soils are often contaminated primarily with lead, but also with metal alloys used for jacketing materials of bullets, such as copper, nickel, iron, and cobalt, and other specialty munitions and penetrators, such as tungsten and depleted uranium. These materials may leach into groundwater at unacceptable levels that do not satisfy the Federal or regional water quality criteria.

SSF or BFF media may be utilized as an impact berm (e.g., the trapezoidal embankment material situated behind targets into which bullets ultimately penetrate and come to rest). For example, an impact berm may measure about 100 ft long by 20 ft deep by 20 ft high, and therefore may utilize 40,000 cubic feet of slag fines assuming a unit weight of 120 lb/ft³, or about 2,400 tons. If slag fines are utilized as the material for impact berms in the approximately 3,000 firing ranges in the U.S., approximately 7.2 million tons of slag fines would be used. In addition, if the entire firing range area was made out of slag fines, in order to minimize any potential metals contamination, the amount of slag fines utilized may increase by at least one order of magnitude, i.e. 72 million tons of slag fines. In some embodiments, SSF and BFF media can also be used in berm systems including its attendent runoff, drainage, and water conveyance systems. In some embodiments, SSF and BFF media can be used as a ground covering at a firing range. In some embodiments SSF and BFF media can be mixed or blended with contaminated soils at firing ranges or other locations with contaminated soils.

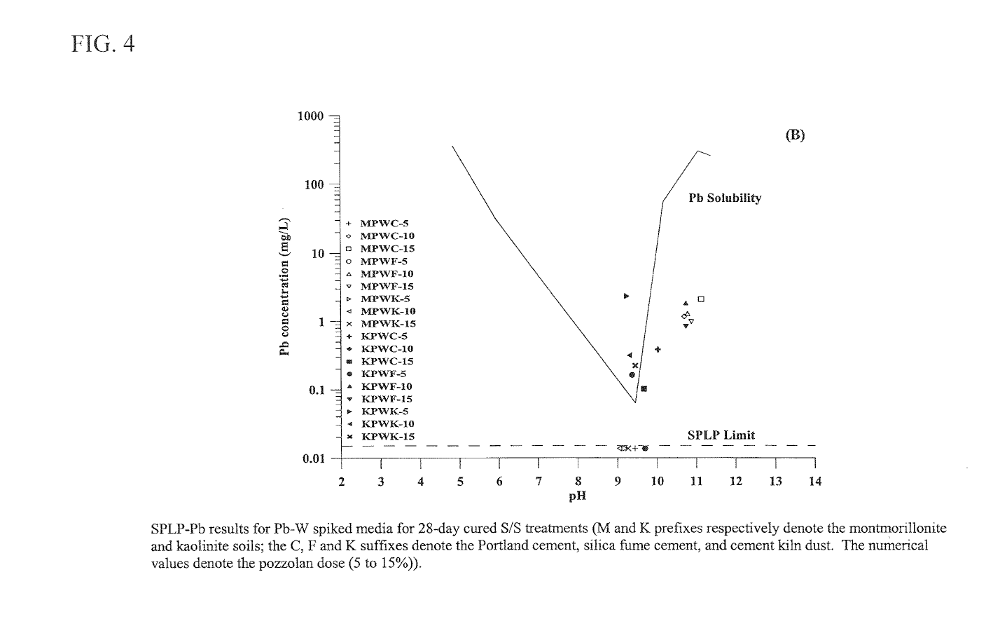

Lead is a main contaminant of concern at firing ranges. As shown in FIG. 4, experiments have been conducted to stabilize lead in artificially lead-contaminated soils utilizing various pozzolans. In particular, montmorillonite (M) and kaolinate (K) clays were spiked with Pb(NO₃)7 at 10% by weight, or 100,000 mg/kg. After being thoroughly homogenized, the samples were placed in sealed 1-L high-density polyethylene (HDPE) containers and were left to mellow for a period of 30 days. After the mellowing period was complete (30 days), the soils were also mixed with Type I/IT Portland cement (PC), silica fume cement (SFC) and cement kiln dust (CKD) to immobilize the artificially lead spiked clays at dosages of 5, 10 and 15 wt % (dry basis) and were allowed to cure for 28 days prior to Synthetic Precipitation Leaching Procedure (SPLP) testing.

The experimentally-determined lead solubility curve of FIG. 4 illustrates that lead achieves its minimum solubilities at mid-range to alkaline (7-10) pH levels under atmospheric conditions. At a pH<9, lead solubility is somewhat influenced by surface adsorption but is mainly solubility controlled. An important interpretation to be made from FIG. 1 is that the combination of soil chemistry—in this case soil type and the pozzolan buffering capacity that produces a pH in the vicinity of 9.5 greatly aids in the precipitation of lead. Moreover, lead may be incorporated in low solubility calcium silicate hydrate (CSH) compounds, which further suppress the Pb concentrations.

### Example 1

Table 2 illustrates that SSF and BFF media are capable of immobilizing lead at unexpected levels. To obtain this data, the SSF and BFF media (SP soil by Unified Soil Classification System) were spiked with a lead salt (PbNO₃) at target concentrations of 500, 1,000, 5,000 and 10,000 mg Pb/kg. The lead salt and a SPLP solution (20:1 liquid to solid ratio) were simultaneously applied to the SSF and BFF media and then they were rotated in a tumbler for 18 hours prior to SPLP extraction using EPA protocols. Tests were run in triplicate and average results are reported in Table 2.

TABLE 2
The SPLP results for the Pb-spiked steel and blast furnace

| | Pb | SPLP |
|---|---|---|
| Sample Description | (mg/L) | pH |
| Blast Furnace Fines (BFF) Control | ND | 10.30 |
| spiked with 500 mg Pb/kg | 0.03 | 10.19 |
| spiked with 1,000 mg Pb/kg | 0.04 | 10.16 |
| spiked with 5,000 mg Pb/kg | 0.11 | 9.25 |
| spiked with 10,000 mg Pb/kg | 0.16 | 8.10 |
| Steel Slag Fines (SSF) Control | 0.23 | 11.85 |
| spiked with 500 mg Pb/kg | 2.39 | 11.81 |
| spiked with 1,000 mg Pb/kg | 6.07 | 11.76 |
| spiked with 5,000 mg Pb/kg | 51.41 | 11.80 |
| spiked with 10,000 mg Pb/kg | 154.87 | 11.88 |

The BFF media achieved somewhat lower lead solubilities due primarily to pH control in and around the pH associated with the minimum solubility of lead in aqueous systems, which is a pH of approximately 9.0. Lead leaching from the BFF media are unexpectedly low given the fact that there was no mellowing or curing time after lead spiking (FIG. 4 shows 30-day mellowing plus 28-days curing). Further, it was unexpected to immobilize up to approximately 10,000 mg/kg lead in a coarse, unstabilized granular media without any attempt at optimization (whereas FIG. 4 shows pozzolanically-stabilized clay with ten times the lead concentration). While the SSF media initially has a pH outside the minimum solubility range of lead (but not other metals, such as copper or nickel), steel slag is very strongly buffered, and initially, the lead concentrations will be high at first, but with time and weathering, the pH will drop into the optimum range for lead and immobilization similar to the BFF. Thus, the long term metals immobilization of lead and other metals in the SSF media is expected to be superior. This is discussed and illustrated below via Acid Neutralization Capacity (ANC) testing results. The result achieved by the TCLP or SPLP extraction is linked to the buffer capacity of the slag fines, which is influenced by its extent of weathering and the strength of the extracting solution allowing metals immobilization to be predictable with time (i.e., design life).

SSF and BFF media illustrate unexpected levels of immobilization for lead and would be of particular use as a lead immobilization media to prevent lead from leaching from contaminated soils or soil-like media into water.

The metals “thresholding” potential of the SSF media was further evaluated to immobilize significant concentrations of several target metals that are relevant to firing range, highway pavement runoff and industrial processes [As(III), As(V), Cd, Cu, P, Pb, Ni, W, Se(IV), Se(VI), Zn]. Aqueous metal solutions were individually prepared by dissolving the corresponding highly-soluble salt in de-ionized (DI) water to achieve target doses equivalent to 100 mg/kg to 100,000 mg/kg to the SSF media, depending on the metal (see Table 3). The SSF media was first wetted (sprayed) with the metals-spiked DI water solution, and then was mixed using a stainless steel spoon to achieve a moisture content of 16%. The metals-spiked SSF media was then stored in sealable plastic bags and allowed to mellow for 30 days. After mellowing, all the samples were air-dried and used for analytical testing.

To batch sufficient SSF media at the 100,000 mg/kg Pb level, the aqueous equivalent of 5,000 mg/L Pb was prepared based on a L:S ratio of 20:1. Due to the volume required, the solution was contacted with the SSF media in a (500 ml polypropylene) standard TCLP bottle that was rotated for 18 hours. The mixture was then transferred to an open stainless steel bowl in a vacuum hood for approximately 24 hours until the free liquid evaporated. Using a spatula, the moist SSF media was then returned to its TCLP bottle, and was mellowed for the balance of the 30 days. A totals analysis of the process revealed negligible loss of Pb.

TABLE 3
Single Metals Thresholding Suite

| | | | Target Dose (mg/kg) | | | | | | |
|---|---|---|---|---|---|---|---|---|---|
| Metal | Reagent | Purity (%) | 100 | 500 | 1000 | 5,000 | 10,000 | 50,000 | 100,000 |
| As(III) | NaAsO₂ | 99.9 | x | x | x | x | x | | |
| As(V) | Na₂HAsO₄•7H₂O | 99.9 | x | x | x | x | x | | |
| Cd | CdCl₂ | 99.4 | x | x | x | x | x | | |
| Cu | Cu(NO₃)₂•2.5H₂O | 99.9 | x | x | x | x | x | | |
| Ni | Ni(NO₃)₂•6H₂O | 99.9 | x | x | x | x | x | | |
| P | NaH₂PO₄•H₂O | 99 | x | x | x | x | x | | |
| Pb | Pb(NO₃)₂ | 99+ | | | x | x | x | x | x |
| Se(IV) | Na₂SeO₃ | 99 | x | x | x | x | x | | |
| Se(VI) | Na₂SeO₄ | 98 | x | x | x | x | x | | |
| W | Na₂WO₄•2H₂O | 99.3 | x | x | x | x | x | | |
| Zn | Zn(NO₃)₂•6H₂O | 99.9 | x | x | x | x | x | | |

All reagents supplied by Fisher Scientific (GA).

The sample size for the TCLP and SPLP analyses was reduced to 25 g. Three replicates each were prepared for each target dose for totals, TCLP and SPLP testing followed by ICP-OES analysis for all metals except for the totals digestion of W. The Cd concentration in the TCLP and SPLP leachates was also determined using a graphite furnace atomic absorption spectrometer (GFAAS, Varian Zeeman Spectra AA 220Z). Prior to analysis, the solutions were acidified using concentrated HNO₃ in an amount of 1%.

The total digestion procedure for the W-containing samples used a modified US Occupational Safety and Health Administration (OSHA) method, namely, Method ID-213 (OSHA, 1994). Acid digestion was performed using 0.5 gram soil aliquots in 125 mL beakers (Phillips) in a three step process. The first extraction used 2 mL (certified ACS grade) for a minimum of 12 hours (overnight). To this soil-extract solution was added 2 mL each of DI water, 85% H₃PO₄, and concentrated HCl, HNO₃ and H₂O₂, and the resulting solution was left overnight. Afterwards, 5 mL of concentrated HNO₃ was added, and the soil-extractant mixture was then refluxed over a hotplate (190° C.) using a ribbed watch glass cover until the mixture was reduced to approximately 2 mL (essentially H₃PO₄). After cooling, the digestate was filtered through No. 42 Whatman filter and remaining solution was diluted to 100 mL using DI water prior to ICP/OES analysis. For quality control purposes the analysis also included the digestion of tungsten powder (99.99% purity, Sigma Aldrich, MO) and matrix-spiked samples.

The single metals thresholding results (except for P) are shown in Tables 4 to 6. The As dosing maximums corresponded to measured totals concentrations exceeding 14,000 and 19,000 mg/kg for the As(III) and As(V) series, respectively. Totals concentrations measured above the target dose can occur as an artifact of the small totals sample size (0.5 g), because the finest fraction of the SSF media tends to wick the spraying water by capillarity and accumulate metals due to specific surface effects. The sample size for the TCLP and SPLP allows a more representative grain size distribution and therefore better reflects composite leaching effects. Under TCLP conditions and interpolating between the dosing targets, the SSF media immobilized approximately 8,250 mg/kg As (III) and 9,000 mg/kg As(V) before exceeding the TCLP-As criteria of 5.0 mg/L. Under SPLP conditions, very likely to due pH considerations, the Federal drinking water criteria were satisfied up to As(III) and As(V) totals concentrations on the order of approximately 1,000 mg/kg.

TABLE 4
SSF Thresholding results for As(III) and As(V) Suites

| | Target Dose | | As(III) | | | | As(V) | | | |
|---|---|---|---|---|---|---|---|---|---|---|
| | Totals | Equivalent | Totals | Conc. | Removal | | Totals | Conc. | Removal | |
| | mg/kg | mg/L | mg/kg | mg/L | % | pH | mg/kg | mg/L | % | pH |
| TCLP | 100 | 5 | 218 | 0.02 | 99.00 | 11.20 | 245 | 0.01 | 99.00 | 11.43 |
| | 500 | 25 | 749 | 0.12 | 99.80 | 11.06 | 742 | 0.12 | 99.80 | 11.10 |
| | 1,000 | 50 | 1,582 | 0.26 | 99.90 | 11.35 | 1,409 | 0.35 | 99.90 | 11.32 |
| | 5,000 | 250 | 9,129 | 1.10 | 99.56 | 10.62 | 9,938 | 3.13 | 98.75 | 10.82 |
| | 10,000 | 500 | 14,222 | 7.07 | 98.59 | 9.89 | 19,226 | 5.46 | 98.91 | 10.12 |
| SPLP | 100 | 5 | same | 0.02 | 99.53 | 12.11 | same | <0.001 | 99.98 | 12.09 |
| | 500 | 25 | as | 0.01 | 99.98 | 12.10 | as | <0.01 | 99.99 | 12.11 |
| | 1,000 | 50 | above | 0.01 | 99.97 | 12.19 | above | 0.01 | 99.98 | 12.13 |
| | 5,000 | 250 | | 0.41 | 99.84 | 12.14 | | 0.73 | 99.71 | 12.13 |
| | 10,000 | 500 | | 2.32 | 99.54 | 12.08 | | 5.67 | 98.87 | 11.94 |

TABLE 5
SSF Thresholding results for typical firing range metals

| | Target Dose | | Cu | | Ni | | Pb | | W | |
|---|---|---|---|---|---|---|---|---|---|---|
| | Totals | Equivalent | Conc. | Removal | Conc. | Removal | Conc. | Removal | Conc. | Removal |
| | mg/kg | mg/L | mg/L | % | mg/L | % | mg/L | % | mg/L | % |
| TCLP | 100 | 5 | 0.03 | 99.41 | <0.05 | 99.00 | — | — | 0.79 | 84.19 |
| | 500 | 25 | 0.03 | 99.88 | <0.05 | 99.80 | — | — | 5.99 | 76.03 |
| | 1,000 | 50 | 0.03 | 99.94 | <0.05 | 99.90 | 0.18 | 99.63 | 9.70 | 80.61 |
| | 5,000 | 250 | 0.04 | 99.99 | <0.05 | 99.98 | 0.13 | 99.95 | 18.18 | 92.73 |
| | 10,000 | 500 | 0.04 | 99.99 | <0.05 | 99.99 | 0.31 | 99.94 | 21.28 | 95.74 |
| | 50,000 | 2,500 | | | | | 1.34 | 99.95 | | |
| | 100,000 | 5,000 | | | | | 2.12 | 99.96 | | |
| SPLP | 100 | 5 | 0.01 | 99.75 | <0.05 | 99.00 | — | — | 0.10 | 98.00 |
| | 500 | 25 | 0.08 | 99.68 | <0.05 | 99.80 | — | — | 0.22 | 99.12 |
| | 1,000 | 50 | 0.11 | 99.78 | <0.05 | 99.9 | 1.66 | 96.68 | 0.52 | 98.95 |
| | 5,000 | 250 | 0.18 | 99.93 | <0.05 | 99.98 | 18.92 | 92.43 | 1.43 | 99.43 |
| | 10,000 | 500 | 0.16 | 99.97 | <0.05 | 99.99 | 55.76 | 88.85 | 2.58 | 99.48 |
| | 50,000 | 2,500 | | | | | 113.91 | 95.44 | | |
| | 100,000 | 5,000 | | | | | 138.72 | 97.23 | | |

Industrial concentrations of copper, cadmium and zinc were immobilized by the SSF media under both TCLP and SPLP conditions to below several Federal drinking water criteria without any attempt at optimization as shown in Tables 5 and 6. For example, cadmium and nickel were removed below their detection limits (DLs) of 0.05 mg/L. Lead leaching complied with the TCLP standard (5.0 mg/L) for totals concentrations up to 100,000 mg/kg. The SPLP-Pb results were lower, due to the pH issues described above with respect to the differences between the SSF and BFF media. Tungsten removal was also extremely high without any attempt at optimization. Selenium, which is extremely difficult to immobilize, was removed at modest levels. But since selenium was tested at high concentrations herein, the SSF media would likely perform well in natural systems with trace Se contamination or as a filtering medium, as further detailed below as another embodiment of the art.

TABLE 6
SSF Thresholding results for typical highway runoff and industrial process metals

| | Target Dose | | Cd | | Se (IV) | | Se (VI) | | Zn | |
|---|---|---|---|---|---|---|---|---|---|---|
| | Totals | Equivalent | Conc. | Removal | Conc. | Removal | Con. | Removal | Conc. | Removal |
| | mg/kg | mg/L | mg/L | % | mg/L | % | mg/L | % | mg/L | % |
| TCLP | 100 | 5 | <0.0005 | 99.99 | 0.43 | 91.33 | 2.7 | 46.01 | 0.03 | 99.49 |
| | 500 | 25 | <0.0005 | 99.99 | 2.43 | 90.28 | 13.69 | 45.22 | 0.04 | 99.85 |
| | 1,000 | 50 | <0.0005 | 99.99 | 5.95 | 88.10 | 29.28 | 41.44 | 0.02 | 99.97 |
| | 5,000 | 250 | <0.0005 | 99.99 | 52.79 | 78.88 | 185.30 | 25.88 | 0.06 | 99.98 |
| | 10,000 | 500 | <0.0005 | 99.99 | 60.11 | 87.98 | 426.87 | 14.63 | 0.02 | 100.00 |
| SPLP | 100 | 5 | <0.0005 | 99.99 | 0.35 | 92.97 | 1.72 | 65.57 | 0.04 | 99.14 |
| | 500 | 25 | <0.0005 | 99.99 | 2.49 | 90.05 | 8.80 | 64.81 | 0.12 | 99.52 |
| | 1,000 | 50 | <0.0005 | 99.99 | 4.70 | 90.60 | 20.40 | 59.19 | 0.29 | 99.43 |
| | 5,000 | 250 | <0.0005 | 99.99 | 9.94 | 96.02 | 130.19 | 47.93 | 1.55 | 99.38 |
| | 10,000 | 500 | <0.0005 | 99.99 | 29.31 | 94.14 | 442.17 | 11.57 | 1.29 | 99.74 |

A series of multi-element thresholding experiments were also conducted with combinations of P, Pb and W (including a P-only control). The main reason for this was that P may have been applied to treat Pb-contaminated firing range soils which may have also contained W, especially on military firing ranges. Concern obviously arises since P has the potential and is known to solubilize W (e.g., aforementioned OSHA method), enhancing the migration potential of W. The goal was to illustrate the ability of SSF to immobilize all three elements simultaneously as a potential remedial approach to P-treatment induced migration of W in firing range soils.

Table 7 shows the P—Pb—W thresholding suite where the pre-existing Pb and/or W contamination was established in the SSF media and mellowed for 30 days as outlined above. The equivalent aqueous doses of Pb and W were 5,000 and 500 mg/L, respectively. The exception to this was the P—Pb—W suite in which the W-spiked SSF media was allowed to mellow and air-dry for approximately 24 hours prior to Pb application by the aforementioned procedure. The Pb—W spiked SSF media was then allowed to mellow for a total of 30 days. A totals analysis of the experimental apparatus revealed no significant mass loss of Pb and/or W by this spiking process.

TABLE 7
P— Pb—W Thresholding Suite

| | Pb Dose | W Dose | PO₄ Target Dose (mg/kg) | | | | |
|---|---|---|---|---|---|---|---|
| Metal | (mg/kg) | (mg/kg) | 100 | 500 | 1000 | 5,000 | 10,000 |
| P | — | — | x | x | x | x | x |
| P, Pb | 100,000 | — | x | x | x | x | x |
| P, W | — | 10,000 | x | x | x | x | x |
| P, Pb, W | 100,000 | 10,000 | x | x | x | x | x |

The pH values of the P spiking solutions (as PO₄) to the P—Pb—W spiked SSF media are shown in Table 8. After P spiking, the P—Pb—W spiked SSF media was allowed to mellow for an additional 30 days (60 days total) prior to being subject to TCLP and SPLP extractions. The mellowed pH of the SSF media and the post-TCLP extraction pH values were also monitored. Total P concentrations were not measured because the SSF media used in the experiments itself contained on the order of 10,334±712 mg/kg PO₄. Tables 8 to 11 contain the experimental results (average of triplicate measurements) for the P—Pb—W thresholding suite.

The ability of SSF to immobilize PO₄ (alone) was very high, as shown in Table 8, which is consistent with the literature on PO₄ removal by slags. The PO₄ immobilization under TCLP and SPLP extraction conditions was <2 and <0.5 mg/L for equivalent aqueous doses up to 500 mg/L, respectively. The final pH of the system appears to have a strong influence on the PO₄ removal efficiency of the SSF media.

TABLE 8
PO₄ Thresholding results for SSF media

| | PO₄ Target Dose | | PO₄ | | | |
|---|---|---|---|---|---|---|
| | Totals | Equivalent | Conc. | Removal | Solution | Extracted |
| | mg/kg | mg/L | mg/L | % | pH | pH |
| TCLP | 100 | 5 | 0.62 | 87.65 | 4.32 | 6.94 |
| | 500 | 25 | 0.85 | 96.59 | 4.32 | 7.46 |
| | 1,000 | 50 | 0.84 | 98.33 | 3.86 | 8.53 |
| | 5,000 | 250 | 1.14 | 99.54 | 3.86 | 7.84 |
| | 10,000 | 500 | 1.72 | 99.66 | 3.86 | 7.55 |
| SPLP | 100 | Same | <0.5 | 90.00 | Same | 12.39 |
| | 500 | As | <0.5 | 98.00 | As | 12.37 |
| | 1,000 | Above | <0.5 | 99.00 | Above | 12.41 |
| | 5,000 | | <0.5 | 99.80 | | 12.40 |
| | 10,000 | | <0.5 | 99.90 | | 12.27 |

TABLE 9
PO₄ Thresholding results for SSF media spiked with 100,000 mg/kg Pb

| | PO₄ Target Dose | | PO₄ | | Pb | | | |
|---|---|---|---|---|---|---|---|---|
| | Totals | Equivalent | Conc. | Removal | Conc. | Removal | Mellowed | Extracted |
| | mg/kg | mg/L | mg/L | % | mg/L | % | pH | pH |
| TCLP | 100 | 5 | <0.5 | 99.00 | 0.09 | 100.00 | 10.23 | 8.10 |
| | 500 | 25 | <0.5 | 98.00 | 0.11 | 100.00 | 10.37 | 7.88 |
| | 1,000 | 50 | <0.5 | 99.00 | 0.13 | 100.00 | 11.04 | 9.18 |
| | 5,000 | 250 | <0.5 | 99.80 | 0.11 | 100.00 | 10.96 | 8.97 |
| | 10,000 | 500 | 0.54 | 99.89 | 0.20 | 100.00 | 10.08 | 8.20 |
| SPLP | 100 | Same | <0.5 | 90.00 | 143.09 | 97.14 | Same | 11.60 |
| | 500 | As | <0.5 | 98.00 | 128.91 | 97.42 | As | 11.58 |
| | 1,000 | Above | <0.5 | 99.00 | 283.73 | 94.33 | Above | 11.81 |
| | 5,000 | | <0.5 | 99.80 | 243.66 | 95.13 | | 11.78 |
| | 10,000 | | <0.5 | 99.90 | 81.51 | 98.37 | | 11.52 |

Table 9 shows the joint immobilization potential of Pb and PO₄ for SSF media initially containing 100,000 mg/kg Pb. In every case, the PO₄ concentration was less than 0.6 mg/L (>90% removal) and the corresponding Pb concentrations were <0.25 mg/L (100.00% removal) for TCLP conditions and were <290 mg/L (94.33% removal min.) for SPLP conditions. An important difference between the TCLP and SPLP conditions was the pH of the extracted leachate. Pb concentrations were lower at moderate pH, PO₄ concentrations remained below the DL (0.5 mg/L) for nine of ten experiments. The presence of PO₄ improved the immobilization of Pb over the Pb-only spiked SSF media (Table 4) by an order of magnitude under TCLP conditions, but the performance was mixed under SPLP conditions.

Table 10 presents the joint immobilization potential of W and PO₄ for SSF media initially containing 10,000 mg/kg W. In every case, the PO₄ concentration was <0.5 mg/L, except for the 10,000 mg/kg PO₄ spiked system under TCLP conditions (1.2 mg/L). The corresponding W concentrations varied between 2 and 16 mg/L with no apparent trend under TCLP conditions, but the W concentrations increased with increasing PO₄ concentrations under SPLP conditions. The presence of PO₄ improved the immobilization of W over a W-only system (Table 5) by approximately 25% to 65% under TCLP conditions, but the concentration of W appeared to increase with increasing PO₄ dose under SPLP conditions from approximately 0.65 times less to 4.5 times more than the Pb-only system.

Table 11 shows the joint immobilization potential of Pb, W and PO₄ for SSF media initially containing 100,000 mg/kg Pb and 10,000 mg/kg W. The mellowed pH values for the Pb—W control values (no P) and the P—Pb—W spiked SSF media mirrored the pH values for the P—Pb spiked SSF system, and were approximately 1 pH unit less than the P—W system. The TCLP extracted pHs were the most uniform and lowest as a group and for the P—Pb—W spiked SSF media followed by the P—Pb systems. The highest pHs were obtained for the P—W system at the lowest P spiking levels. For SPLP extraction conditions, the highest pH values were obtained for the P—W system at low P doses, but thereafter the system results were generally similar but were ordered by the lowest average pH as P—Pb—W, P—Pb and P—W.

TABLE 10
PO₄ Thresholding results for SSF media spiked with 10,000 mg/kg W

| | PO₄ Target Dose | | PO₄ | | W | | | |
|---|---|---|---|---|---|---|---|---|
| | Totals | Equivalent | Conc. | Removal | Conc. | Removal | Mellowed | Extracted |
| | mg/kg | mg/L | mg/L | % | mg/L | % | pH | pH |
| TCLP | 100 | 5 | <0.5 | 99.00 | 15.93 | 96.81 | 11.27 | 10.34 |
| | 500 | 25 | <0.5 | 98.00 | 11.48 | 97.70 | 11.49 | 9.73 |
| | 1,000 | 50 | <0.5 | 99.00 | 9.38 | 98.12 | 10.78 | 8.07 |
| | 5,000 | 250 | <0.5 | 99.80 | 7.43 | 98.51 | 11.10 | 7.18 |
| | 10,000 | 500 | 1.12 | 99.78 | 12.41 | 97.52 | 11.21 | 7.44 |
| SPLP | 100 | Same | <0.5 | 90.00 | 1.67 | 99.67 | Same | 11.97 |
| | 500 | As | <0.5 | 98.00 | 2.30 | 99.54 | As | 12.01 |
| | 1,000 | Above | <0.5 | 99.00 | 3.03 | 99.39 | Above | 11.88 |
| | 5,000 | | <0.5 | 99.80 | 11.70 | 97.66 | | 11.68 |
| | 10,000 | | <0.5 | 99.90 | 11.64 | 97.67 | | 11.80 |

TABLE 11
PO₄ Thresholding results for SSF media spiked with 100,000 mg/kg Pb and 10,000 mg/kg W

| | PO₄ Target Dose | | PO₄ | | Pb | | W | | | |
|---|---|---|---|---|---|---|---|---|---|---|
| | Totals | Equivalent | Conc. | Removal | Conc. | Removal | Conc. | Removal | Mellowed | Extracted |
| | mg/kg | mg/L | mg/L | % | mg/L | % | mg/L | % | pH | pH |
| TCLP | 0 | 0 | — | — | 1.28 | 99.97 | 3.52 | 99.30 | 10.22 | 8.13 |
| | 100 | 5 | 0.54 | 89.25 | 0.18 | 100.00 | 0.69 | 99.86 | 10.11 | 7.85 |
| | 500 | 25 | 0.51 | 97.97 | 0.12 | 100.00 | 1.09 | 99.78 | 10.47 | 8.55 |
| | 1,000 | 50 | 0.61 | 98.79 | 0.21 | 100.00 | 0.92 | 99.82 | 9.98 | 7.95 |
| | 5,000 | 250 | 0.5 | 99.80 | 0.24 | 100.00 | 0.95 | 99.81 | 10.07 | 7.78 |
| | 10,000 | 500 | <0.5 | 99.90 | 0.23 | 100.00 | 0.85 | 99.83 | 9.91 | 7.61 |
| SPLP | 0 | Same | — | — | 124.67 | 97.51 | 1.28 | 99.74 | Same | 11.60 |
| | 100 | As | <0.5 | 90.00 | 115.53 | 97.69 | 0.26 | 99.95 | As | 11.51 |
| | 500 | Above | <0.5 | 98.00 | 182.57 | 96.35 | 0.24 | 99.95 | Above | 11.67 |
| | 1,000 | | <0.5 | 99.00 | 76.20 | 98.48 | 0.15 | 99.97 | | 11.49 |
| | 5,000 | | <0.5 | 99.80 | 101.97 | 97.96 | 0.22 | 99.96 | | 11.47 |
| | 10,000 | | <0.5 | 99.90 | 45.08 | 99.10 | 0.31 | 99.94 | | 11.37 |

It is important to note that P is not required to achieve high Pb and W immobilization levels in SSF media as evidenced by the data contained in Table 5 and the Pb—W control data shown in Table 11. Rather, the SSF media is also effective in immobilizing P, without significant reduction in (and even enhancement to) Pb and W immobilization. While the PO₄ concentrations fluctuated around the DL (0.5 mg/L) under TCLP conditions for all P dosing levels, PO₄ was BDL under SPLP conditions for all P dosing levels.

The TCLP-Pb concentrations were lowered by an order of magnitude with P addition in the Pb—W controls and Pb-only spiked SSF media (Table 5), the results being similar but slightly higher than the P—Pb spiked SSF media for corresponding P dosing levels. However, the SPLP-Pb concentrations generally increased with increasing P dosing level (versus the Pb—W control), and overall, the SPLP-Pb concentrations were less than the corresponding P dosing levels in the P—Pb spiked system.

W immobilization was highest in the P—Pb—W spiked media, followed in order by the Pb—W control data (Table 11), the P—W spiked SSF media (Table 10) and W-only spiked media (Table 5) for corresponding dosing levels for TCLP and all SPLP data sets except the P—W spiked SSF media, which has the lowest removal rates, potentially due to P-induced increases in W solubility, or oxyanionic competition for precipitating cations. Also, the presence of Pb appears to have a larger influence on W immobilization than P, perhaps due to the formation of stolzite (PbWO₄). The increased immobilization of W from the P—W system to the P—Pb—W system due to the presence of Pb is generally on the order of a magnitude or more. The W concentrations in the P—Pb—W spiked SSF are the lowest observed for the tested experimental conditions and seemingly independent of P dose.

The ability of the SSF media to immobilize heavy metals is quite rapid, as evidenced by batch equilibration experiments. Batch kinetics experiments were conducted using aqueous solutions at a dose equivalent to 10,000 mg/kg per metal for As(III), As(V), Cd, Cu, Ni, W and Zn, 100,000 mg/kg for Pb, see Table 12. The selected sampling intervals were 1, 2, 5, 10, 60 minutes, and 3, 6, 12 and 18 hours. Sacrificial samples were prepared in triplicate for each metal and time interval. For each replicate, 6.5 g of dry SSF media was placed in 130 mL bottle. For all samples, aqueous metal solution was added to the sample (total liquid volume 130 mL) using a L:S of 20:1, identical to the TCLP/SPLP procedure. The resultant slurries (in triplicate; A to C) were mixed in an end-over-end rotator at 30 rpm. At each interval, triplicate samples were removed and the supernatants were filtrated through a 0.45 μm nylon membrane filter. The pH of the leachate was recorded using an Accumet AR20 pH-meter. All samples were stored in the refrigerator at a temperature of 4° C. before they were analyzed by ICP-OES. Table 12 also summarizes the pH of the equilibrated salt solutions and the final leachate pH (18 hours).

TABLE 12
Target doses and salts of select heavy metals used for Kinetics and ANC tests

| | | | Target Dose | | Equivalent | | |
|---|---|---|---|---|---|---|---|
| | | | (mg/kg) | | Aqueous Dose | | |
| Metal | Reagent | Purity (%) | 10,000 | 100,000 | mg/L | pHₒ | pH_{f} |
| As(III) | NaAsO₂ | 99.9 | x | | 500 | 10.25 | 12.00 |
| As(V) | Na₂HAsO₄•7H₂O | 99.9 | x | | 500 | 8.96 | 12.04 |
| Cd | CdCl₂ | 99.4 | x | | 500 | 4.91 | 12.60 |
| Cu | Cu(NO₃)₂•2.5H₂O | 99.9 | x | | 500 | 4.29 | 12.36 |
| Ni | Ni(NO₃)₂•6H₂O | 99.9 | x | | 500 | 4.76 | 12.23 |
| Pb | Pb(NO₃)₂ | 99+ | | x | 5,000 | 4.12 | 12.12 |
| W | Na₂WO₄•2H₂O | 99.3 | x | | 500 | 7.14 | 12.62 |
| Zn | Zn(NO₃)₂•6H₂O | 99.9 | x | | 500 | 6.92 | 12.20 |

All reagents supplied by Fisher Scientific (GA).
pHₒ—initial pH of metal salt solution.
pH_{f}—final leachate pH, 18 hours equilibration time.

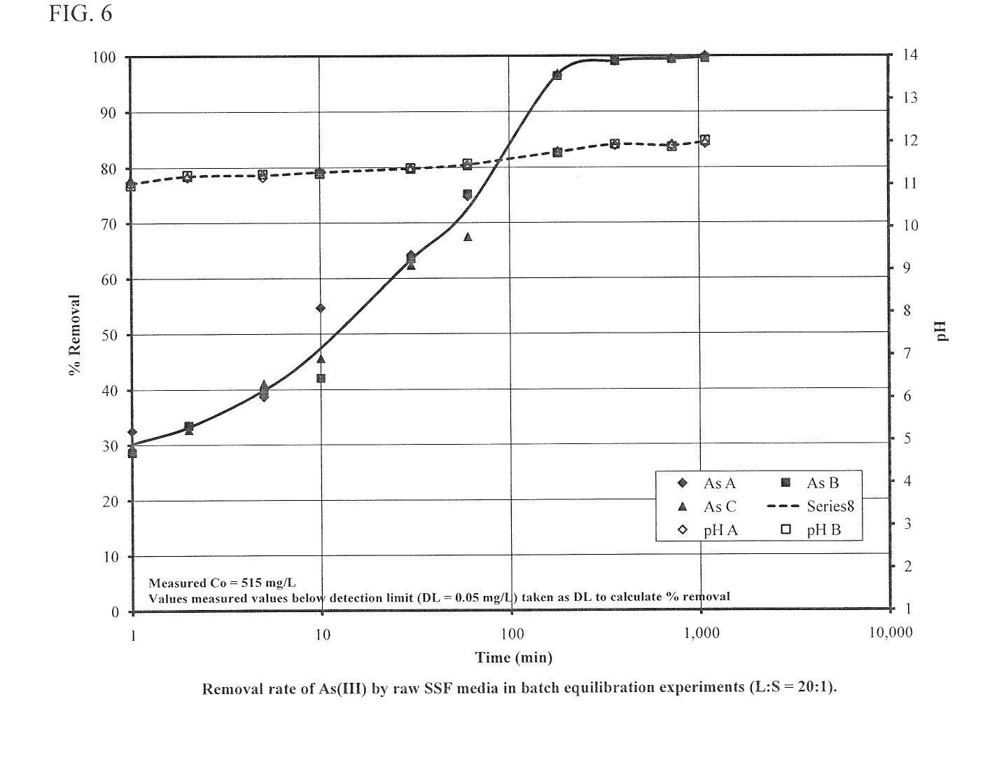

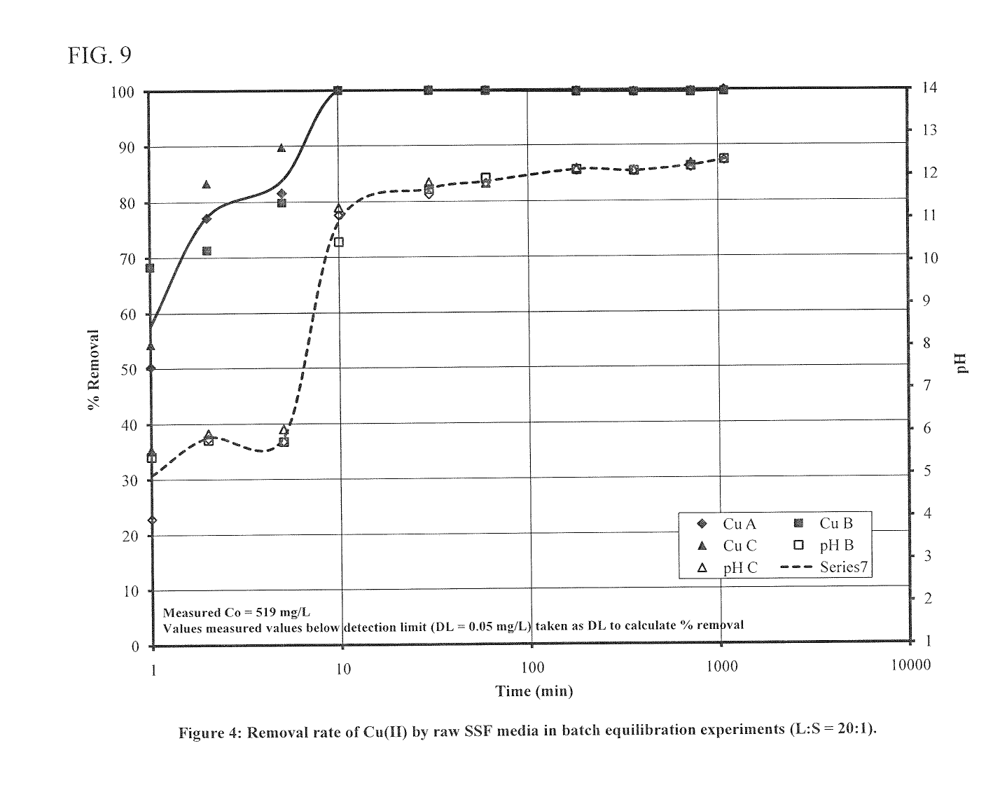

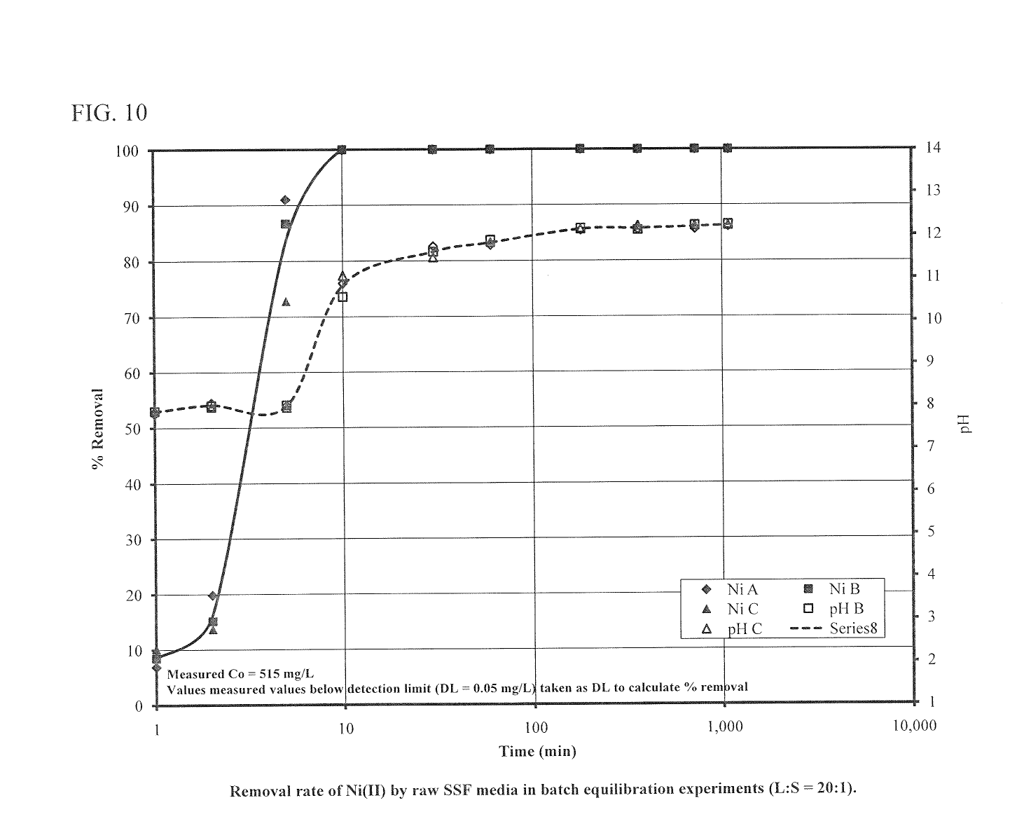

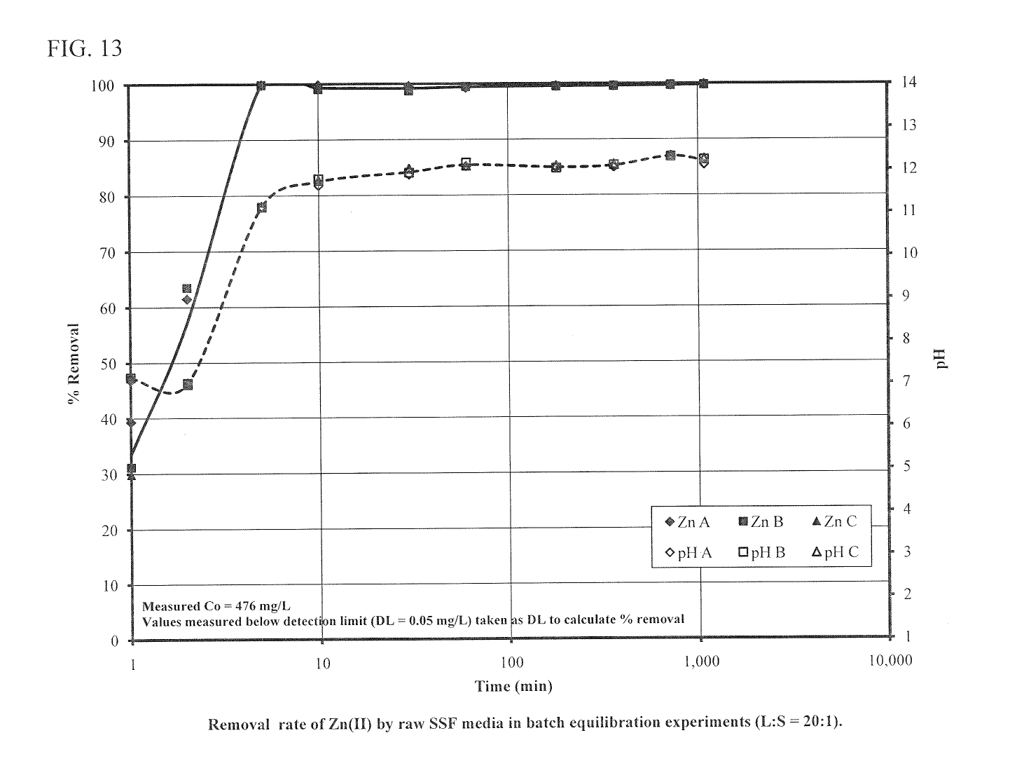

FIGS. 6 to 13 present the percent removal of each metal and the pH shift as a function of time. Each figure shows the measured concentration (Cₒ) of each metal provided along with the DL (0.05 mg/L) of the ICP-OES. Concentrations below the detection limit (DL=0.05 mg/L) were plotted as DL and were also used as basis for percent removal calculations. The percent removal was calculated as (Cₒ—C)/Cₒ.

The initial pH of the aqueous salt solution (pHₒ) of the cationic metals, Cd, Cu, Ni and Pb was less than 5 and for Zn, the pHₒ was less than 7. The pHₒ for the oxyanions, As (III), As(V) and W was greater than 7. Metals removal was imparted due to the pH change in some systems. For the cationic metals, Cu, Ni, and Zn, the leachate pH was increased to 11 within 5 to 10 min, due to the strong buffering capacity of the SSF media. For Cd, the leachate pH was increased to 11 within 1 min, probably due to the hydration behavior of the Cd cation. For Pb, whose dose was 10 times higher than the other metals, the leachate pH increased to 11 within 3 hrs.

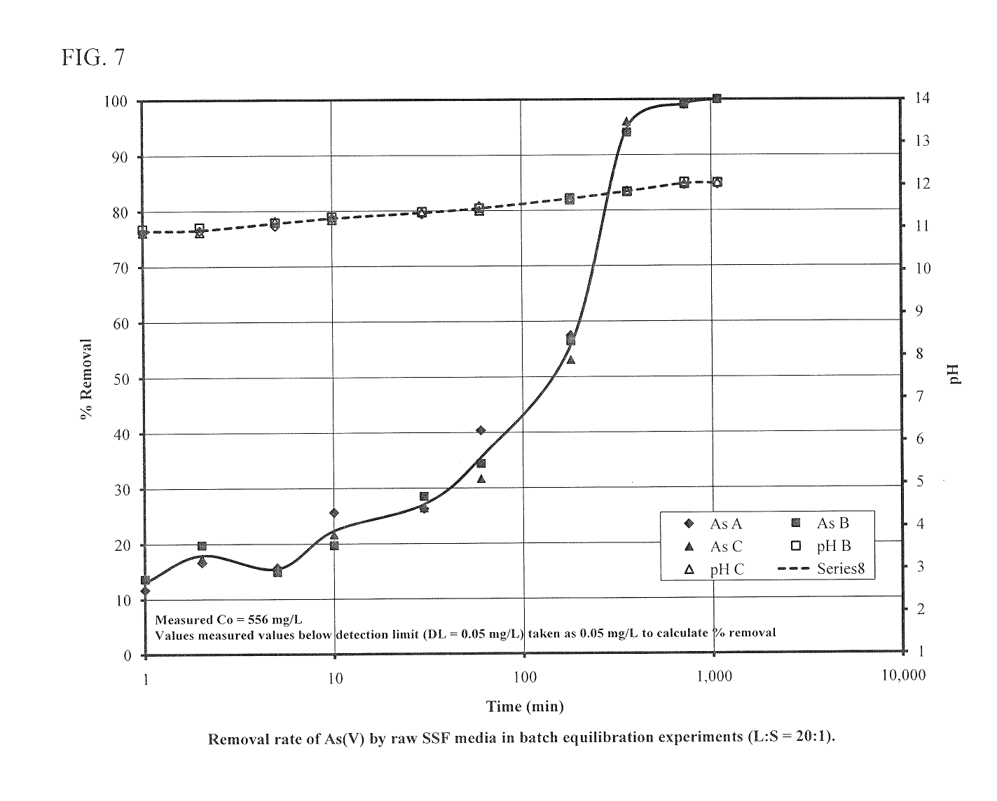

The percent removal of all the metals by SSF was about 99% after 18 hrs mixing time, except for Pb, which was about 93% (FIGS. 6 to 13). This could be due to the elevated Pb dose used in this study. FIGS. 6 and 7 show the percent removal by SSF of As(III) and As(V) and the leachate pH as a function of equilibration time. The peak As(III) removal (99%) was achieved by the SSF media within 6 hrs, whereas As(V) peak removal (99%) occurred by 12 hrs. The leachate pH of these solutions varied between 11 and 12.

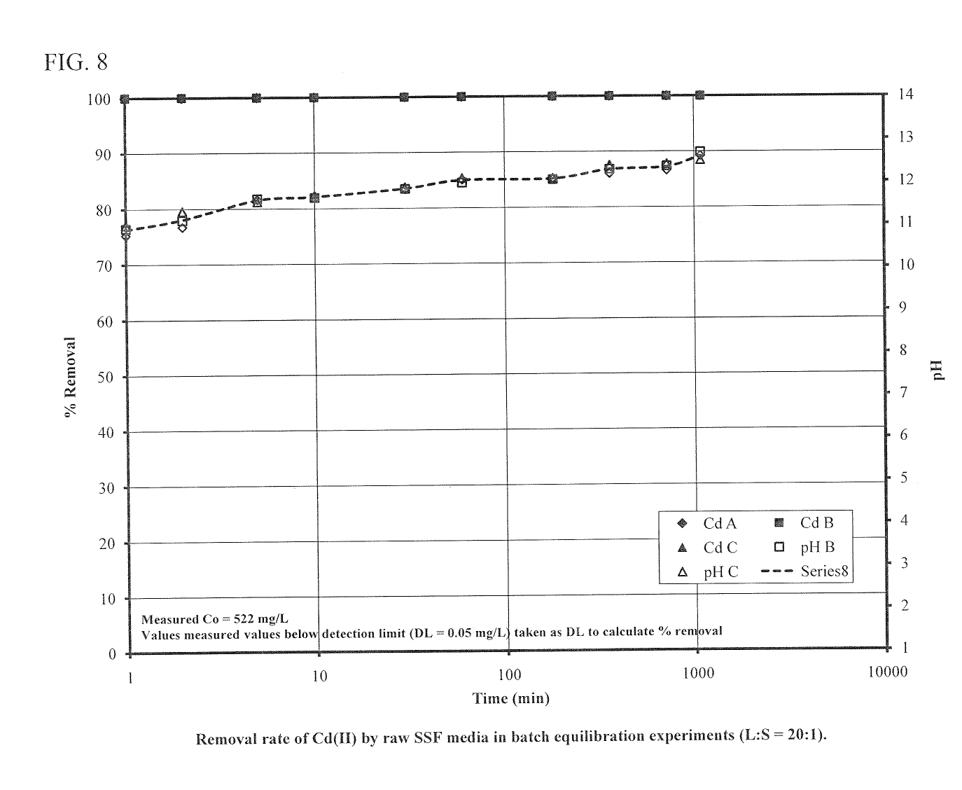

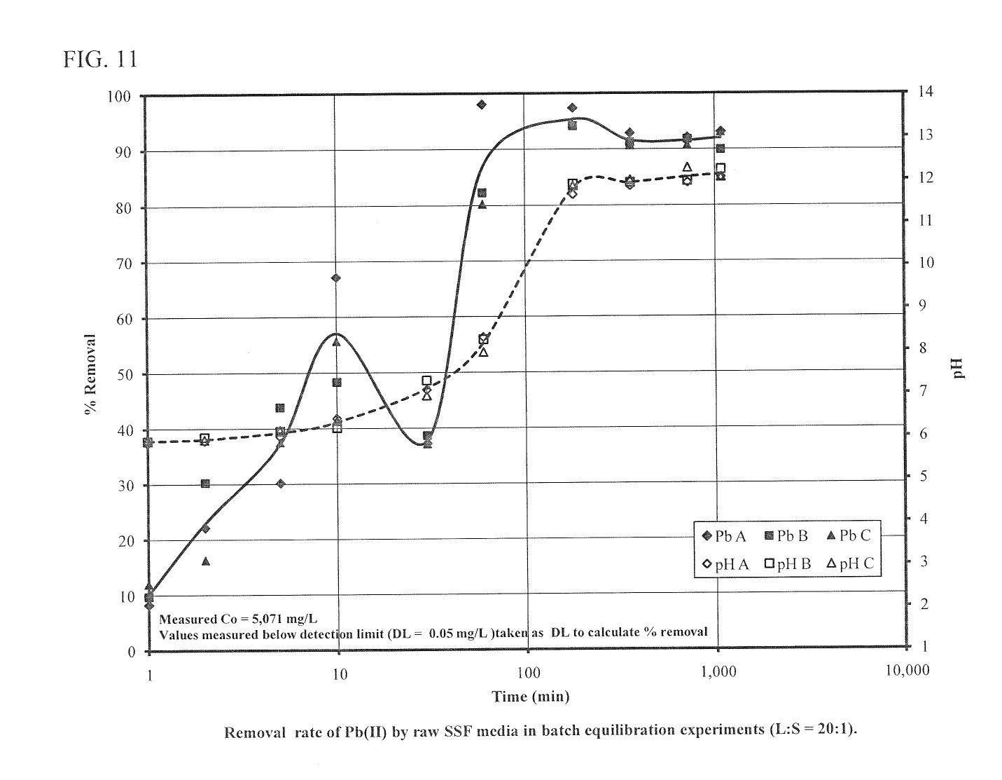

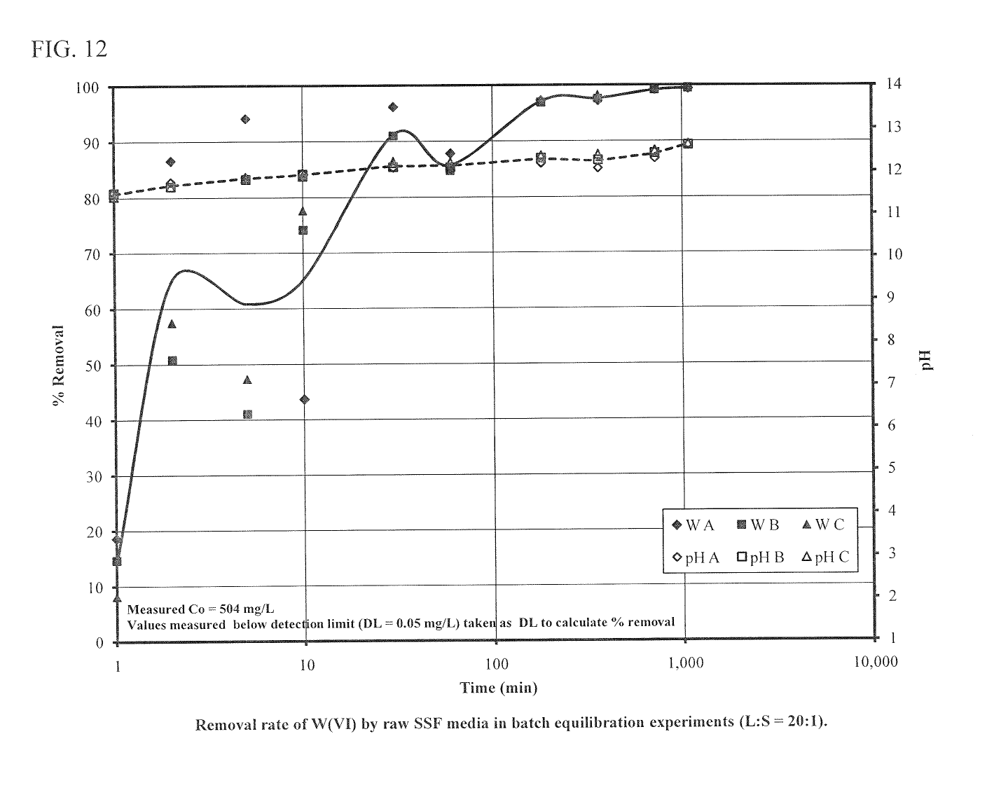

The removal of Cd, Cu, Ni and Zn appear to be largely pH controlled (FIGS. 8, 9, 10, 13), consistent with the ANC results presented in a later section. As the leachate pH increased to 11, there was approximately 99.9 percent removal of each metal. FIG. 11 shows that percent removal of Pb increased when pH was between 5.5 and 6.5, decreased at pH closer to 7 and increased again when pH >8. The removal of W increased with pH above 12, to approximately 99.5% at 18 hrs (FIG. 12).

### Filter Medium

In another embodiment, slag fines may be used as a filter medium (e.g., layer, mat, canister, trench, chimney, trickling filter, reactive subbase) through which heavy metals laden water (mine, surface, ground, leachate or process) flows either in a loose or compacted state. The slag fines may partially reduce or wholly eliminate the aqueous phase concentrations of the metals. The slag fines may be used alone or mixed or blended with a sand or other inert or sorptive granular media to form a metals immobilization media that acts as a filtering medium.

In one example, a layer of slag fines could be placed as a drainage layer directly underneath a contaminated soil or soil-like media structure or pile, such as a traditional impact berm in a firing range, fly ash monofill, or heap leach pad to treat infiltrating water that contains metal contaminants prior to it passing into the subsoil. The layer can be placed loose or compacted to act as a semi-permeable metals immobilizing layer. In another example, a trench may be filled with slag fines at the bottom of a sloped structure or pile of contaminated soil or soil-like media, such as the bottom of an embankment, to intercept, treat, and divert water runoff. In another example, slag fines may be placed between two layers, such as a non-woven fabric or other geosynthetic, to form a reactive mat or pad that may be used as a drainage layer directly underneath a contaminated soil or soil-like media structure fill or pile, such as fly ash monofill. In such an instance, the slag fines would act as a reactive layer that intercepts and treats contaminated water prior to release. In general, the slag fines may be placed in the flow path of contaminated water to act as a filter medium to partially reduce or wholly eliminate the aqueous phase concentrations of metals in the contaminated water.

### Example 2

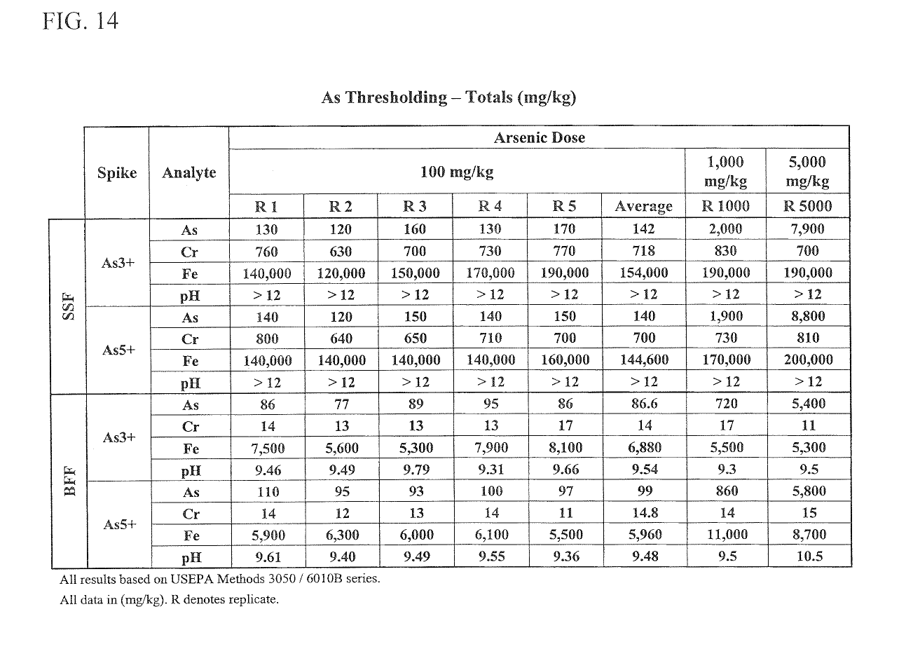

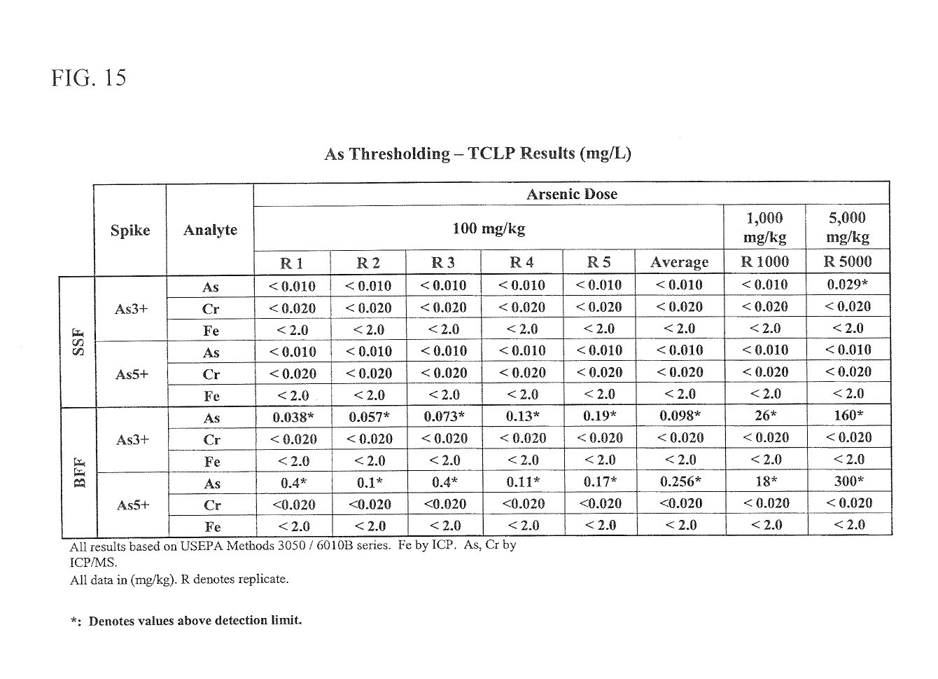

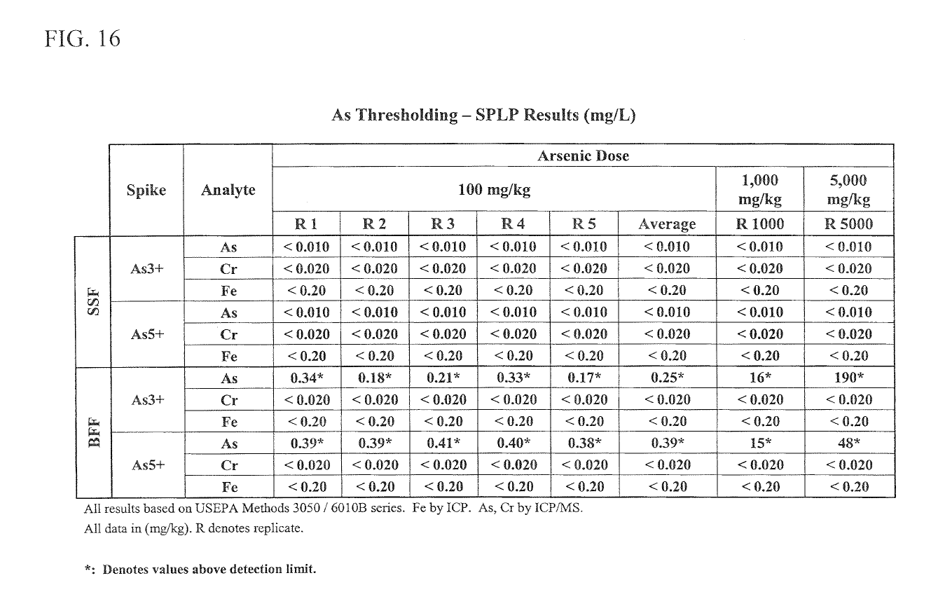

In one embodiment, SSF and BFF media and their blends, for example those having the bulk chemistry shown in FIG. 1 and the environmental quality shown in FIGS. 2 and 3, may be utilized as a filtering medium to immobilize arsenic. To illustrate the relative ability of SSF and BFF media to individually immobilize arsenic, As thresholding experiments were conducted with both media. The dosing or spiking procedure for the raw SSF and BFF media involved As(III) and As(V) target concentrations of between 100 and 5,000 mg/kg, each prepared separately. The SSF and BFF media were wetted (sprayed) with arsenic-spiked water and mixed with a stainless steel spoon to achieve a moisture content of 16% and 14%, respectively. The As-spiked media were allowed to mellow for 30 days, air dried, then analyzed as previously described. FIG. 14 shows the measured total of the As-spiked SSF and BBF media versus their target (dose) concentrations. The Cr, Fe totals and pH were also measured. FIGS. 15 and 16 show the corresponding TCLP and SPLP leaching results, respectively. The SFF media immobilized up to 7,900 mg As(III)/kg and 8,800 mg As(V)/kg to less than 0.030 mg/L and less than 0.010 mg/L, respectively. The corresponding SPLP results for the SSF media were non-detectable. The corresponding As reductions for the BFF media were also good, but not as high as the SSF media.

### Example 3

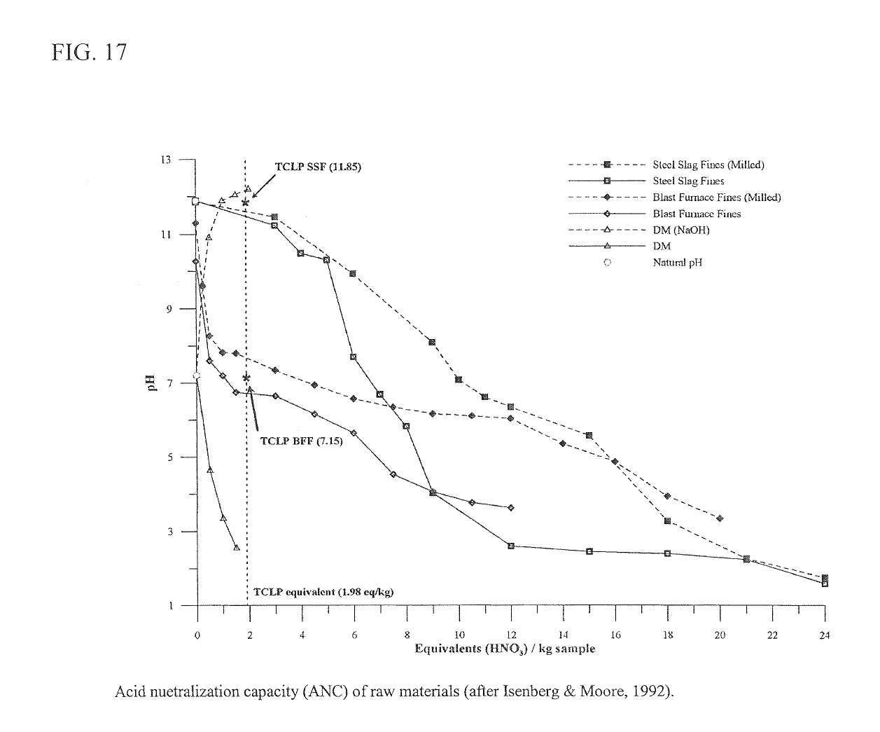

Acid neutralization capacity (ANC) testing was performed on the SFF and BFF media to measure the buffer capacity of each system in response to an acid attack, which could be taken to simulate time in the case of an acid rain exposure condition, e.g., repeated additions (equivalents) of an acid of known strength, as shown in FIG. 17. Dredged material (DM) data is also shown in FIG. 17 because SFF and BFF media may be blended with DM to create an engineered fill, as discussed in more detail later, and also to immobilize metals in the DM to prevent leaching. Partially de-watered DM, such as that having the bulk chemistry shown in FIG. 1, for example, may be utilized. In the case of the ANC testing of DM, since the SSF media was alkaline, the base neutralization capacity was evaluated up to pH of approximately 12, the natural pH of the SSF media. At any specified pH interval, the dissolved As, Cr and Fe concentrations were measured.

The raw SSF, BFF, and DM media having the environmental quality shown in FIGS. 1, 2, 3 and 5 were tested. To determine if there were any particle size effects that would impact the performance of the SSF or BFF media, they were pulverized to destroy any nodules, lime balls or other morphological features that would control solubility of different constituents or pH. The milled SSF and BFF samples (SSFM and BFFM) were prepared using a Fritsch Planetary Ball Mill. Approximately 40 g of air-dried SSF of BFF was placed into the milling container and was pulverized for 15 minutes at a rotation speed of 250 RPM. The entire sample was pulverized to pass through a U.S. No. 100 sieve (0.15 mm).

The ANC test procedure was based on the Generalized Acid Neutralizing Capacity test of Isenberg and Moore (1992). The procedure consisted of equilibrating the soil samples to increasing equivalents of reagent per kilogram of dry soil. Specifically, 6.5 grams of each dry sample were placed in a series of 130 mL bottles. For strongly alkaline media, incremental amounts of 15.8N nitric acid (HNO₃) were added to the sample (total liquid volume 130 mL), using a liquid:solid ratio of 20:1, identical to the TCLP and SPLP procedures. For the DM, incremental amounts of 10N sodium hydroxide (NaOH) were added to the sample to illustrate the impacts of alkalinity on the sample.

The resultant slurries were tumbled in a standard TCLP rotating extractor for 48 hours. The supernatants were then filtrated through a 0.45 μm nylon membrane filter, and the pH of the leachate was recorded using an Accumet AR20 pH-meter. All samples were stored in the refrigerator at a temperature of 4° C. before they were analyzed for testing of pH total and dissolved As, Cr, and Fe.

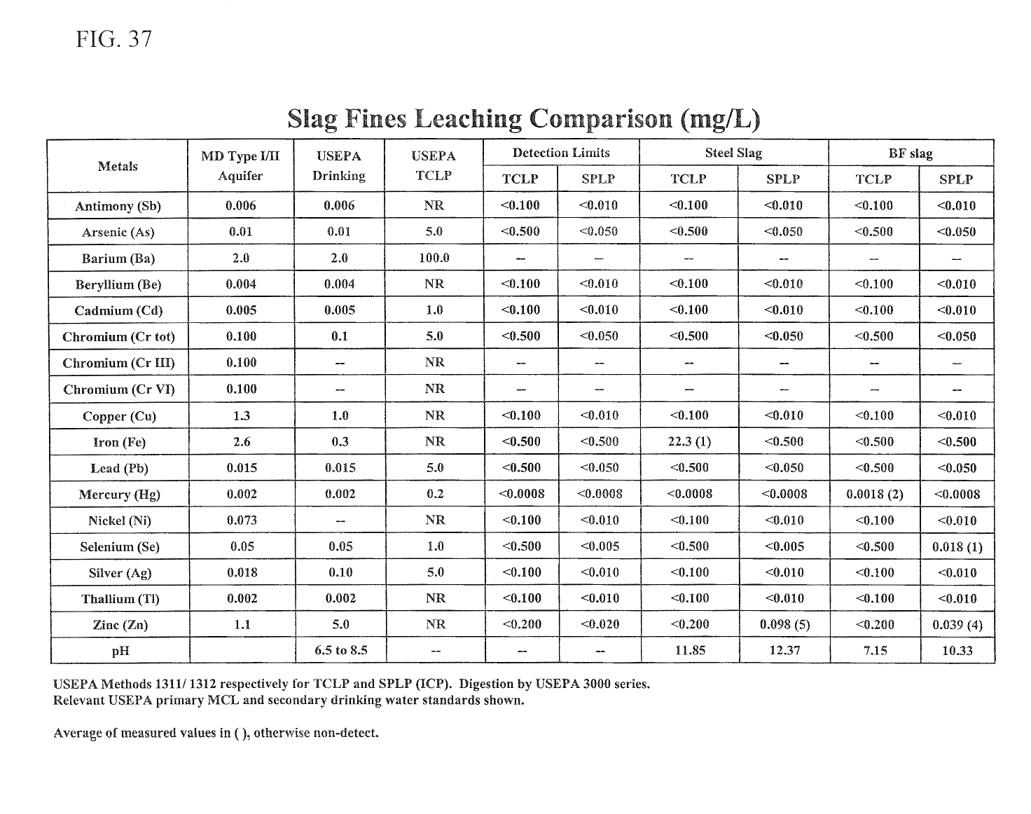

FIG. 17 shows the ANC of the raw materials for up to 24 eq/kg soil. For comparison purposes, the TCLP data of the SSF media (FIG. 37, discussed below) matches well with the ANC result. The legend also shows the strength of an SPLP solution (1.12 meq/kg), which is approximately 1,765 times weaker than a TCLP solution. Hence, a SPLP leach essentially abuts the Y-axis. Two portions of a DM curve are shown because of its moderate pH, an acidification curve (HNO₃) and an alkaline curve (NaOH). The steep ANC curves and their short range illustrate the weak buffering capacity of the DM.

The SSF media consumed approximately 7 acid eq/kg to reach a neutral pH (7) and approximately 11 acid eq/kg to achieve a pH of about 3. The response of the SSFM sample was much stronger, requiring approximately 10 and 18 acid eq/kg to attain a pH of about 3. This suggests that destroying the morphology of the SSF media liberates alkalinity due to grain size effects, whether it be in the form of lime or other pH buffering minerals.

From the ANC data, the SSF media will likely persist at an elevated pH for long periods. This has the double effect of preventing As leaching from the DM and keeping the pH above the range to support microbial transformations of the DM which lead to its ultimate acidification.

### Example 4

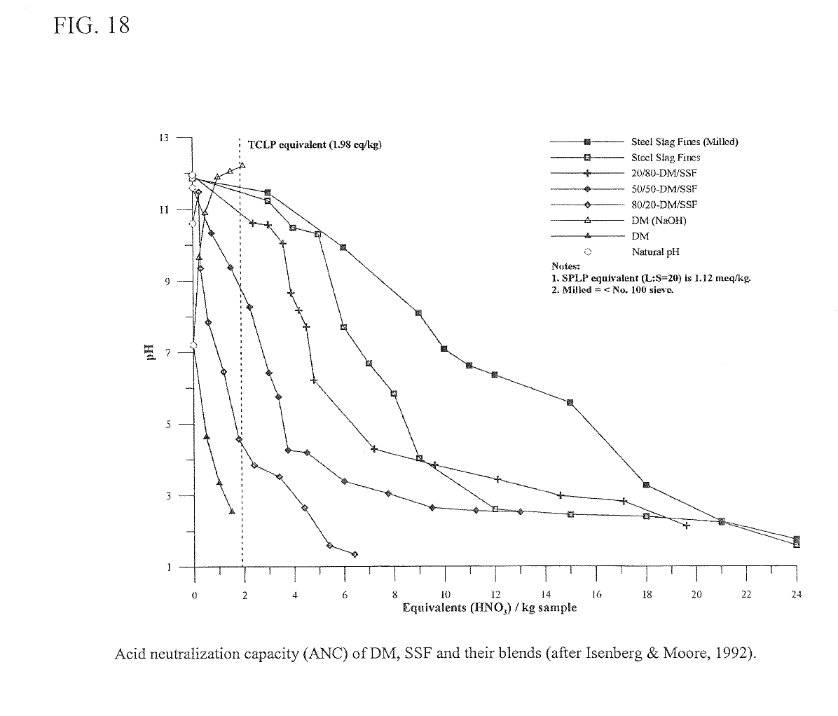

To illustrate how the SSF media buffered the DM, the DM and SSF media were proportioned and blended to prepare the 80/20, 50/50 and 20/80 DM-SSF blends (dry weight basis) where the DM content is reported first. These blends were homogenized and cured for 7 days prior to ANC testing (Example 3). The DM and SSF media were evaluated as is without a curing time. None of these samples were As spiked. FIG. 18 shows the ANC curves for the DM, SSF media and their blends. The SSF media significantly increased the buffering capacity of the DM, and the family of curves parallels the 100% SSF curve above pH 4, showing a 2 eq/kg difference between the curves.

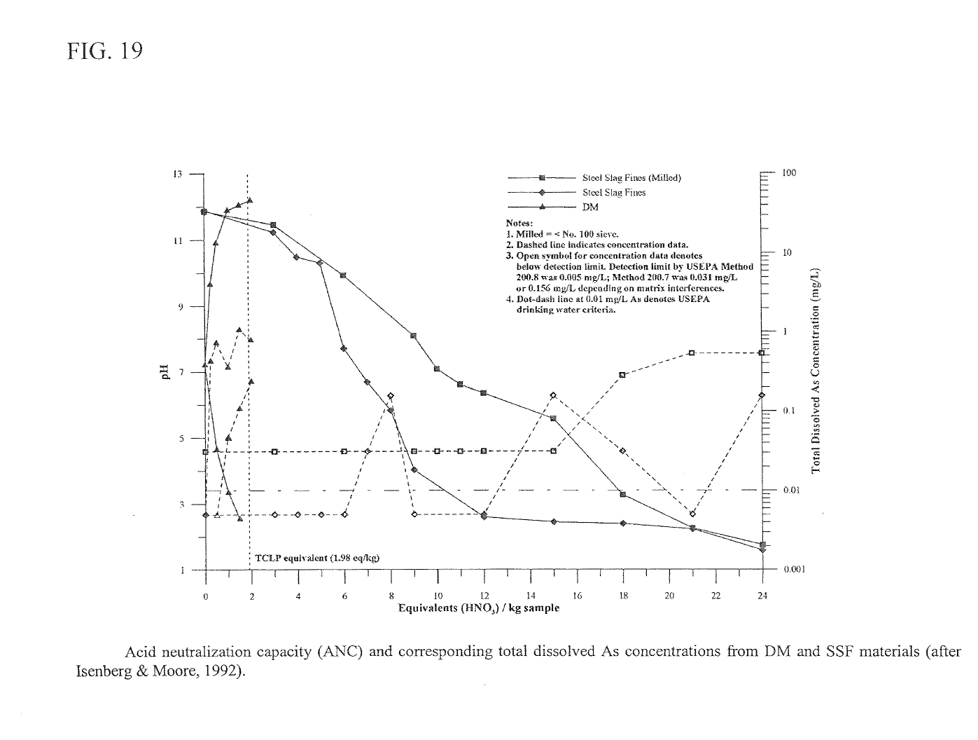

FIG. 19 shows the ANC-As concentrations (dashed lines) for the raw DM and both SSF media, to illustrate the role of milling on metals leaching. The USEPA As drinking water standard is shown at 0.01 mg/L. The open symbols used for the concentration plots denote the detection limits for that particle sample, which varied because of the use of ICP vs ICP/MS for different samples depending on the matrix interferences.

The As in the DM is liberated very easily and quickly exceeded the drinking water criteria, whereas the As concentration from the SSF and SSFM samples never exceed the detection limit (which fluctuates due to matrix issues). The leaching of Cr from DM increases dramatically with increasing pH, as expected.

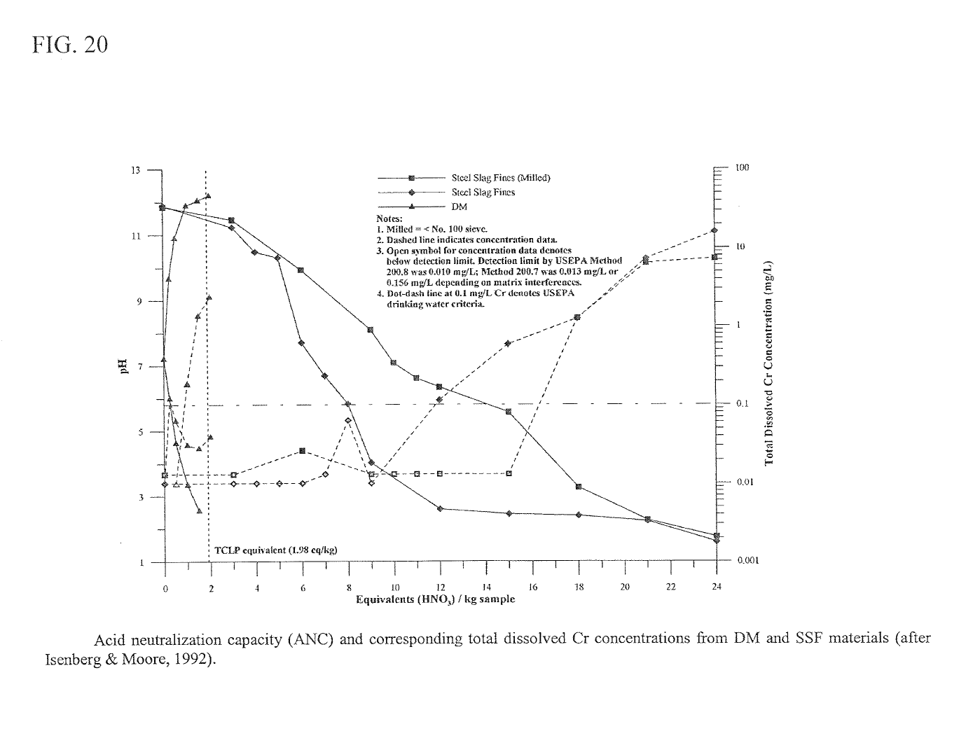

FIG. 20 shows the ANC-Cr concentrations for the raw DM and both SSF media.

The USEPA Cr drinking water standard is shown at 0.1 mg/L. The Cr is likewise liberated from the DM relatively easily with increasing pH. On the other hand, it takes 12 to 14.5 eq/kg to release Cr from the SSF media (6× to 7× TCLP condition) to values above the Federal drinking water criteria.

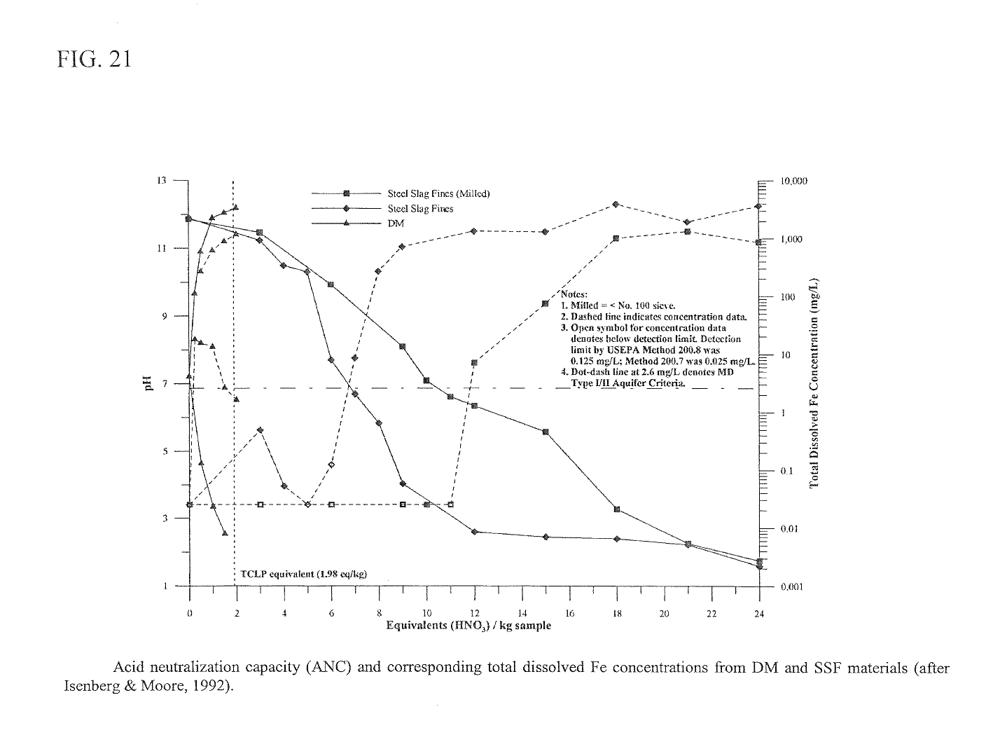

FIG. 21 shows the ANC-Fe concentrations for the raw DM and both SSF media.

### Example 5

To further illustrate the strong buffer capacity of SSF and its corresponding release of metals under acid attack, the doses of metals shown in Table 12 were used to individually spike the SSF media followed by the mellowing procedure outline above. After mellowing, they were subject to ANC testing as previously described using triplicate samples for each acid equivalent added. The release of Ca, Fe and Mg, which were indigenous to the SSF media itself, were also measured.

To determine if the release of metals was solubility controlled (aqueous system), the concentration-pH behavior of each heavy metal was simulated using Visual Minteq, Version 2.61 (David and Allison, 1999). The target dose of each heavy metal was used as the control concentration (Co), see Table 12. The control concentrations of Ca, Fe and Mg were selected based on a comparison of the converted measured totals (XRF) and total digestion data, as shown in Table 13. The totals data were taken to be more representative based on the accuracy (and aggressiveness) of the extraction process. Iron was further speciated as Fe(II) and Fe(III) directly in the sold phase using (XANES), see Table 1. Also shown in Table 13 are the respective Ca, Fe and Mg concentrations in the ANC controls.

TABLE 13
Input concentrations used in Minteq to determine Me—H₂O solubility curves for ANC data

| | XRF | | Total Digestion | | ANC Control | |
|---|---|---|---|---|---|---|
| | Total | Equivalent | Total | Equivalent | Aqueous | |
| | concentration | Aqueous | concentration | Aqueous | concentration | |
| Element | (mg/kg) | (mg/L) | (mg/kg) | (mg/L) | (mg/L) | % leached |
| Ca | 265,936 | 13,297 | 330,000 | 16,500 | 7,002 | 42 |
| Fe(II)^{a} | 60,942 | 3,047 | 102,190 | 5,110 | 916 | 18 |
| Fe(III)^{a} | 53,661 | 2,683 | 89,980 | 4,499 | 807 | 18 |
| Mg | 62,173 | 3,109 | 78,000 | 3,900 | 1,034 | 27 |

^{a}based on XANES speciation

The aqueous database of Minteq was augmented with the aqueous data of the relevant species cited from literature. The solubility curves for different elements obtained from the Minteq model were plotted with the experimental data. For Pb only, an experimentally-determined Pb solubility curve obtained from synthetic Pb solutions (Dermatas and Meng, 2003) is also shown for comparison purposes because Minteq modeling results did not match other Pb solubility data in the literature (USEPA, 1986 and others). The Minteq predicted Pb curve shows it to be less soluble than other elements it is known not to be less soluble than (e.g., Cd). It is worth noting here that all Minteq simulations were run for pure systems and did not consider complex phenomena due to multi element systems such as the ones at hand. Moreover, adsorption modules were not considered in the simulation runs.

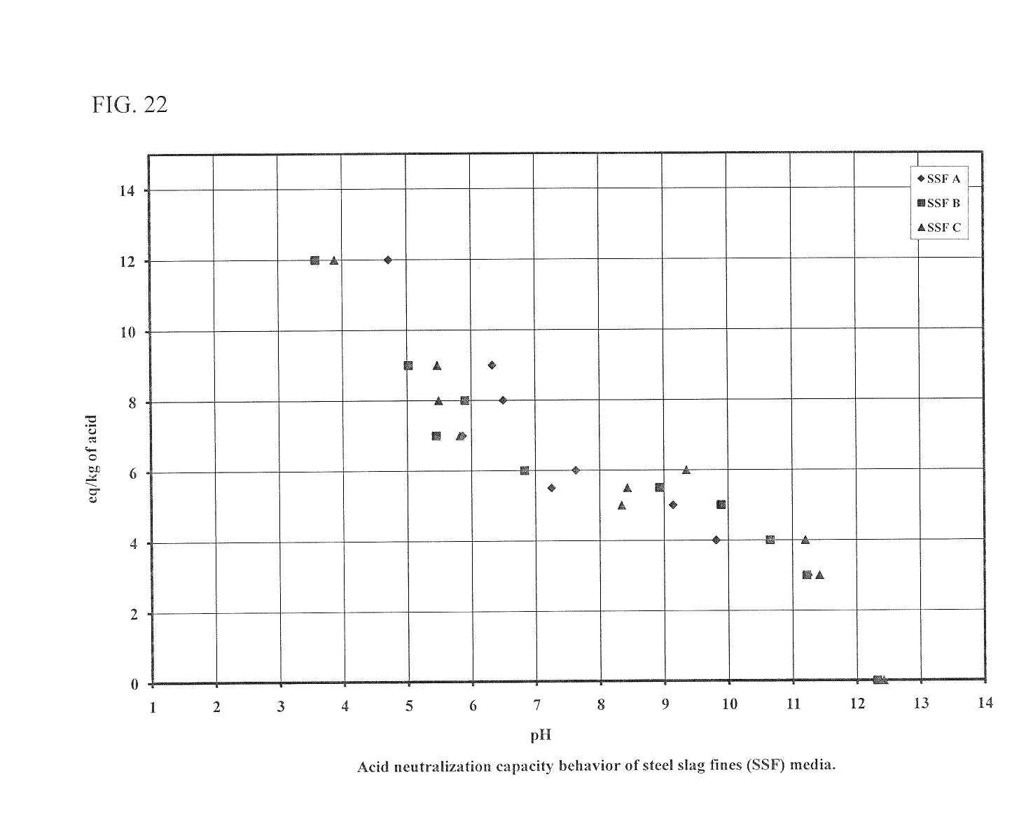

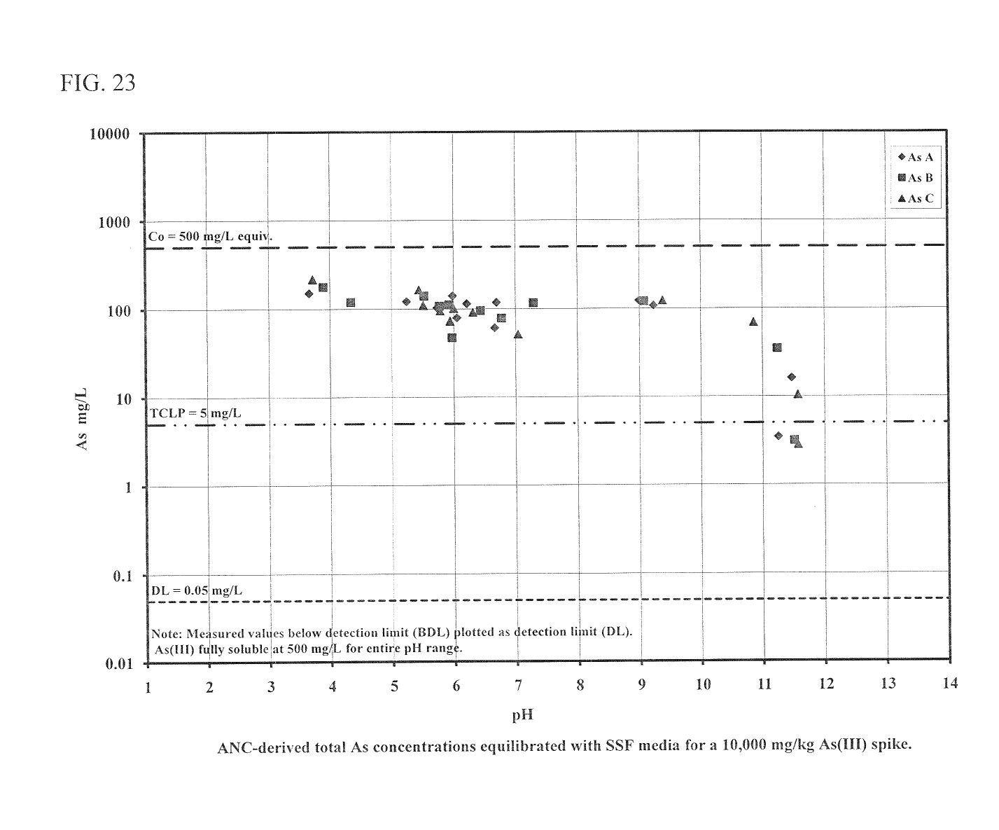

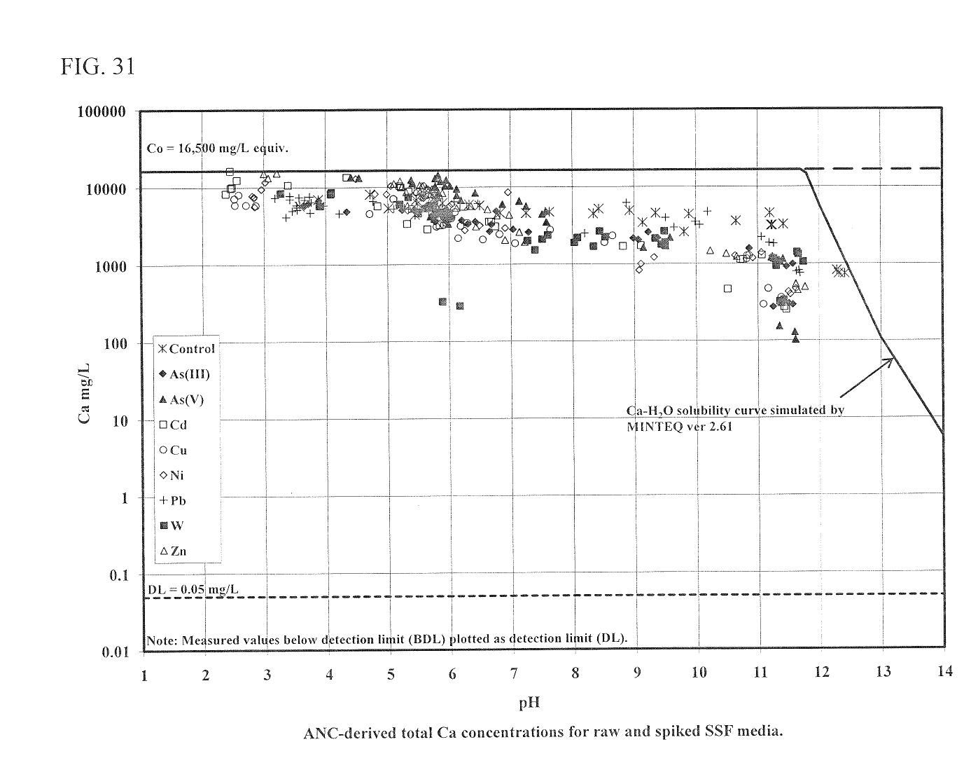

FIG. 22 presents the ANC results of the raw SSF media used in this suite of experiments. FIGS. 23 to 30 present the ANC-derived metals concentrations as a function of pH for As(III), As(V), Cd, Cu, Ni, Pb, W and Zn, respectively. FIGS. 31 to 33 present the corresponding dissolved concentrations of Ca, Fe, and Mg, respectively, as a function of the heavy metal to determine ion dependent solubility effects.

In terms of buffering capacity, the control sample (raw SSF) consumed approximately 7 eq/kg to achieve a neutral pH, and approximately 12 eq/kg to achieve pH˜3 as shown in FIG. 22, consistent with prior results (FIG. 17). However, due to the nature of the added salts, the heavy metals spikes themselves consumed alkalinity, requiring only the addition of approximately 3 to 4 eq/kg of acid to reach a neutral pH. The cationic metals Cd, Cu, Ni, Pb and Zn required approximately 12 eq/kg to achieve pH˜3, whereas the oxyanions [As(III), As(V) and W] did not necessarily achieve a pH of 3, even after the addition of 12 eq/kg.

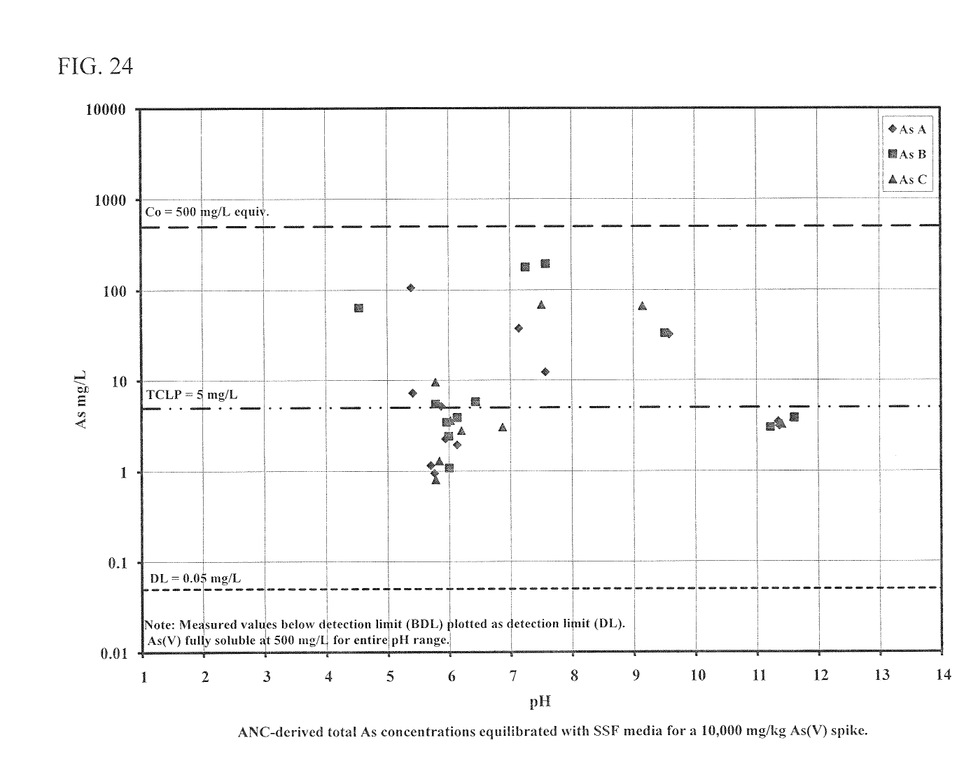

FIGS. 23 and 24 and model simulations showed that for pure systems As(III) and As(V) were fully soluble for the tested pH range. However, the experimental data showed a fivefold reduction in concentration for As(III) for a broad range of pH. The TCLP is satisfied at an approximate pH of 11.5, see FIG. 23. The concentrations of As(V) between pH values of 5 and 7 are less than 10 mg/L, and at pH >11, the As(V) concentrations are <5 mg/L. As(V) occurs in the form of oxyanion As0₄²⁻ and adsorption could be the dominant phenomenon between the pH values of 5 and 7, see FIG. 24.

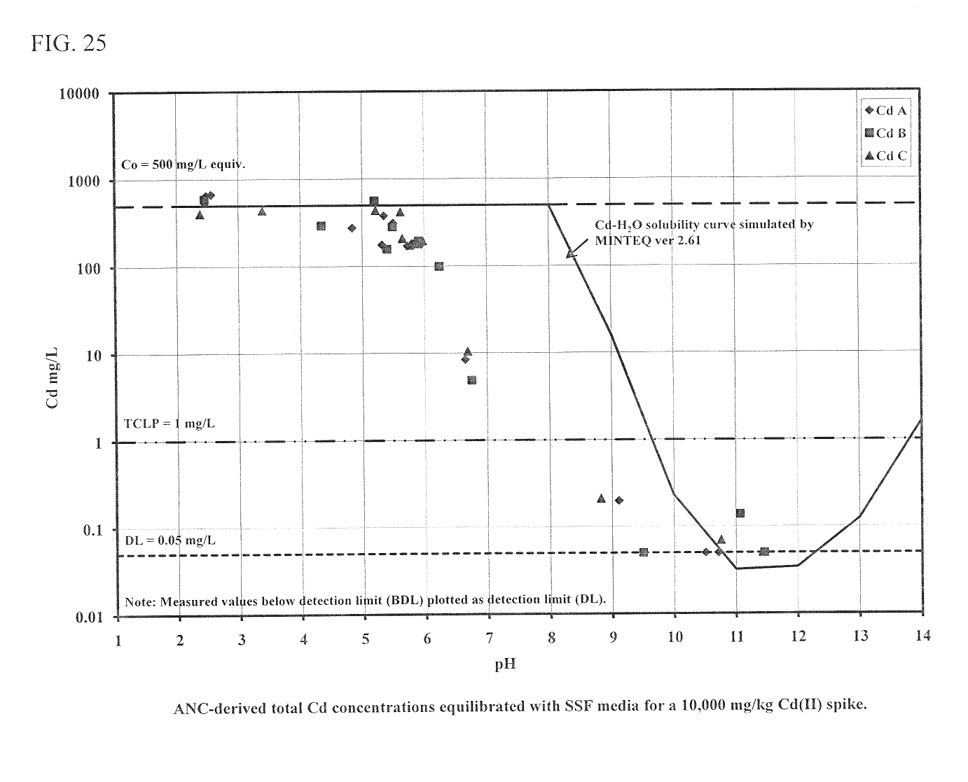

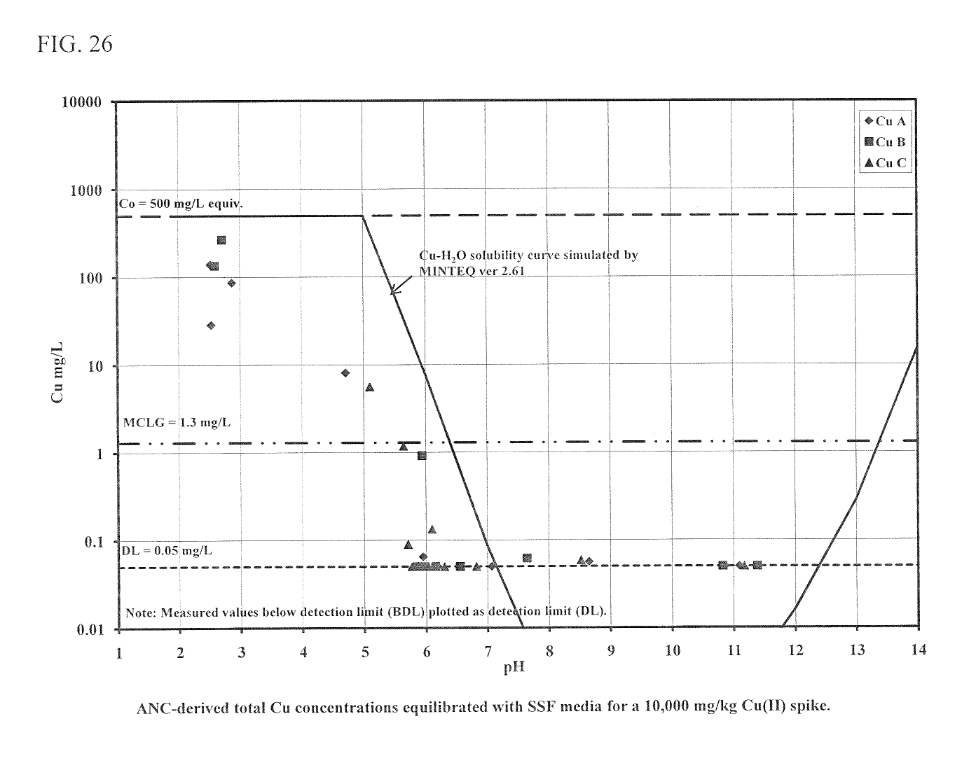

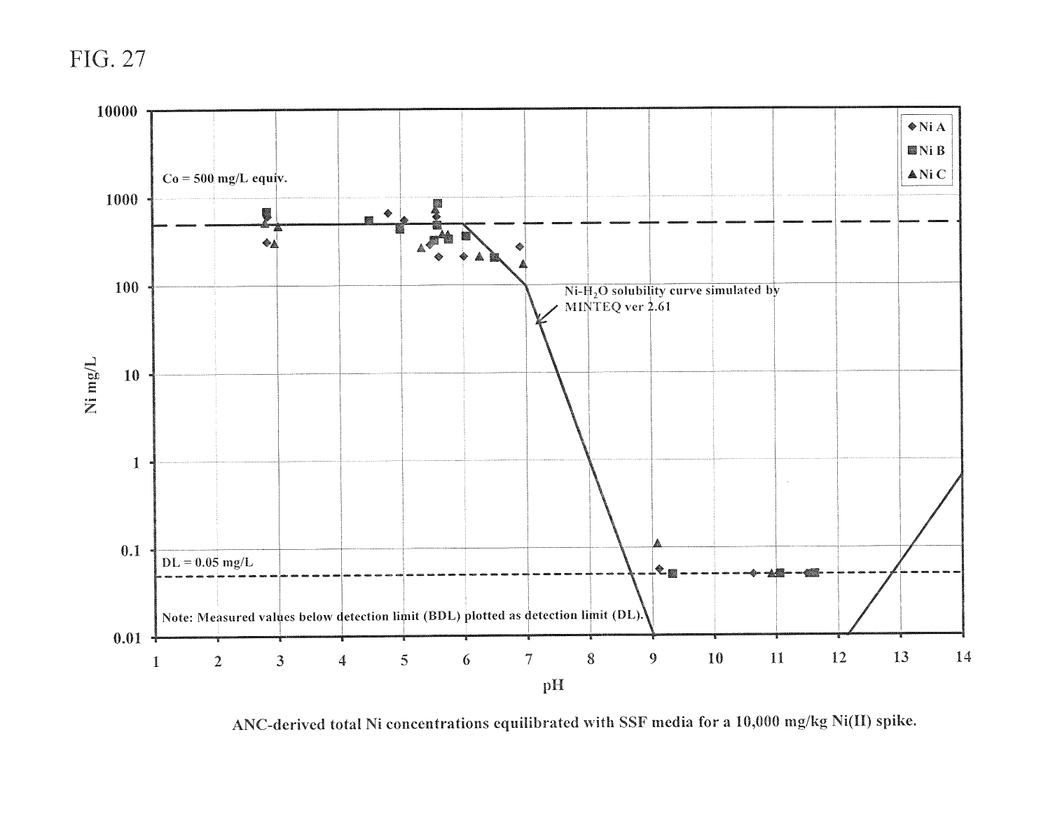

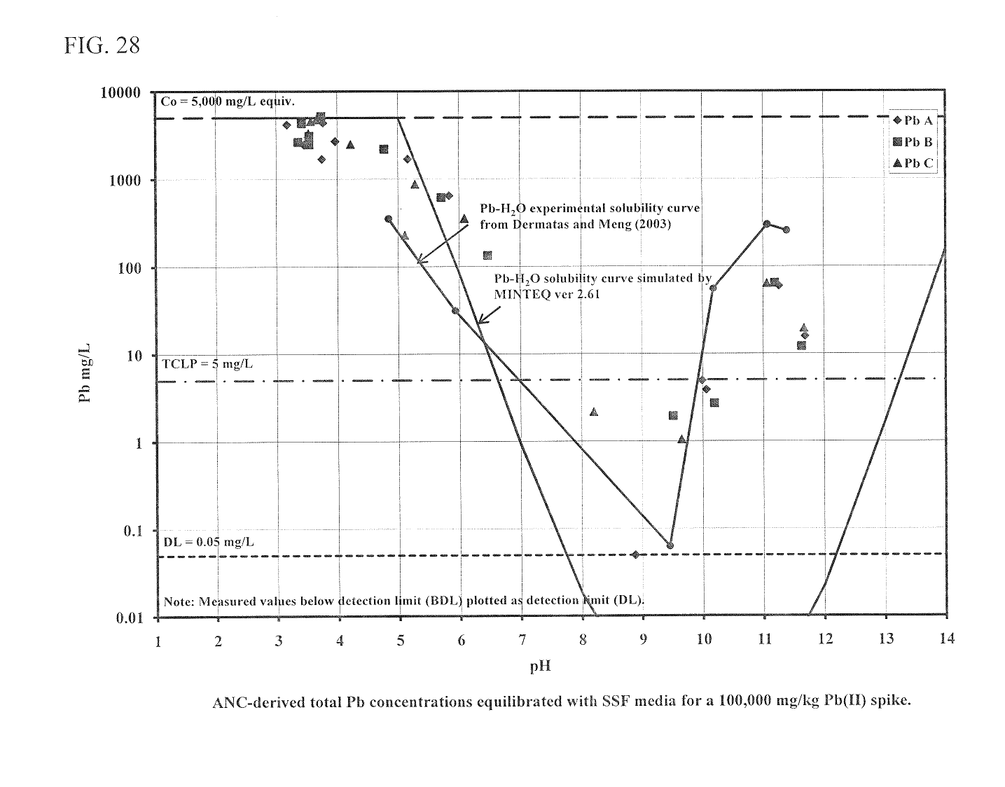

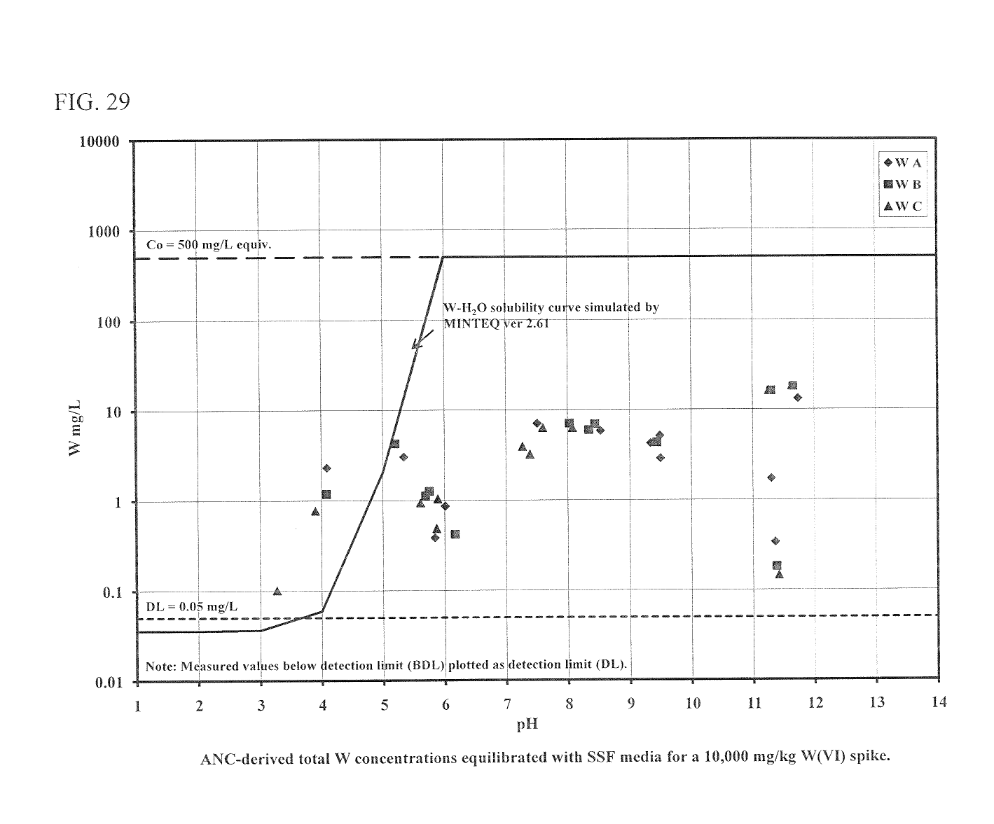

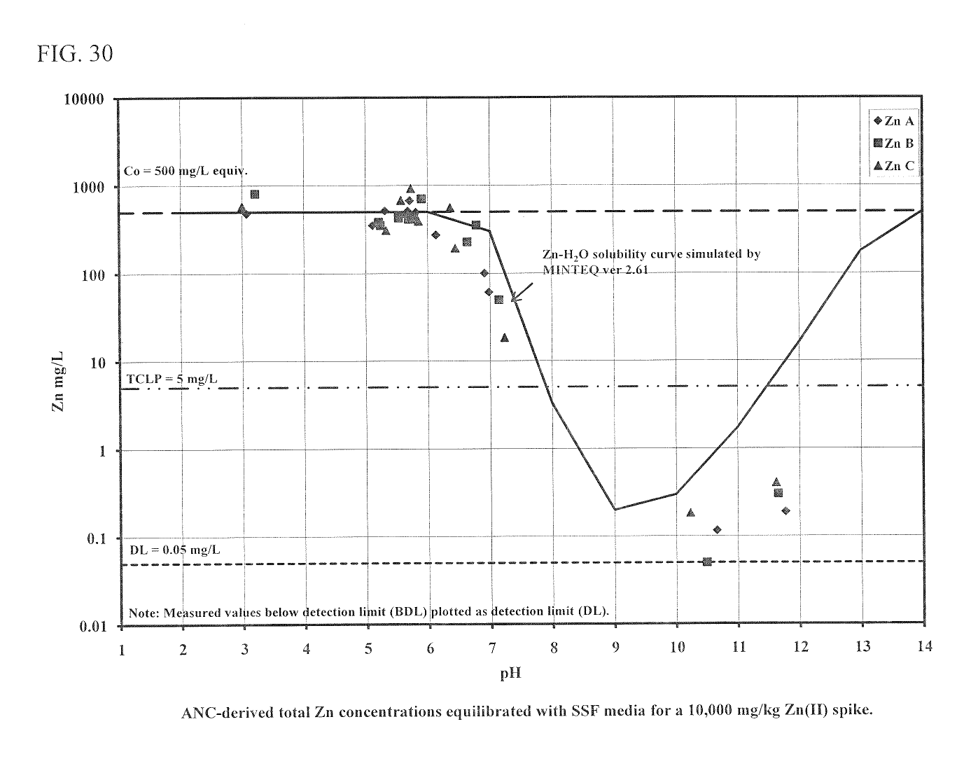

FIGS. 25 and 26 illustrate that Cd and Cu were suppressed below their solubility limits, sometimes significantly, between pH of 5.5 to 10 and 3 and 7, respectively. Above these values, both metals are insoluble and their concentrations were almost always non-detectable. Nickel and lead concentrations desorbing/dissolving from the SSF media appears to be largely solubility controlled, see FIGS. 27 and 28. Tungsten appears more difficult to remove, with concentrations persisting at least 50 times below the reference concentration above pH 6 (FIG. 29). Zinc behavior also appears to be largely pH controlled (FIG. 30), the concentrations being significantly suppressed at elevated pH above 9.

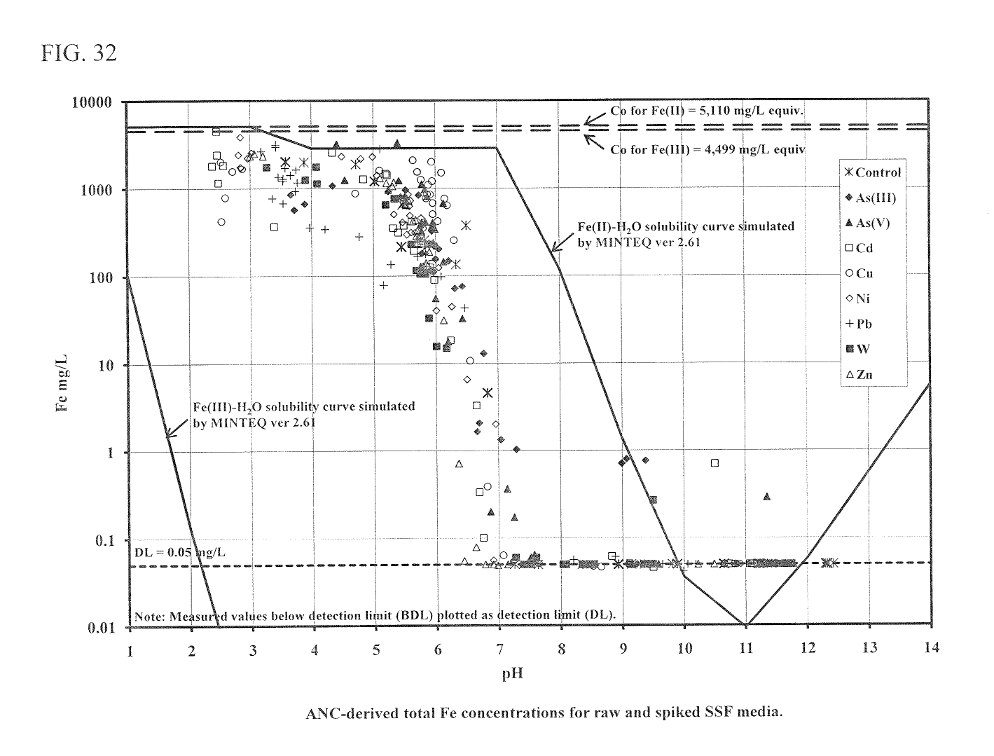

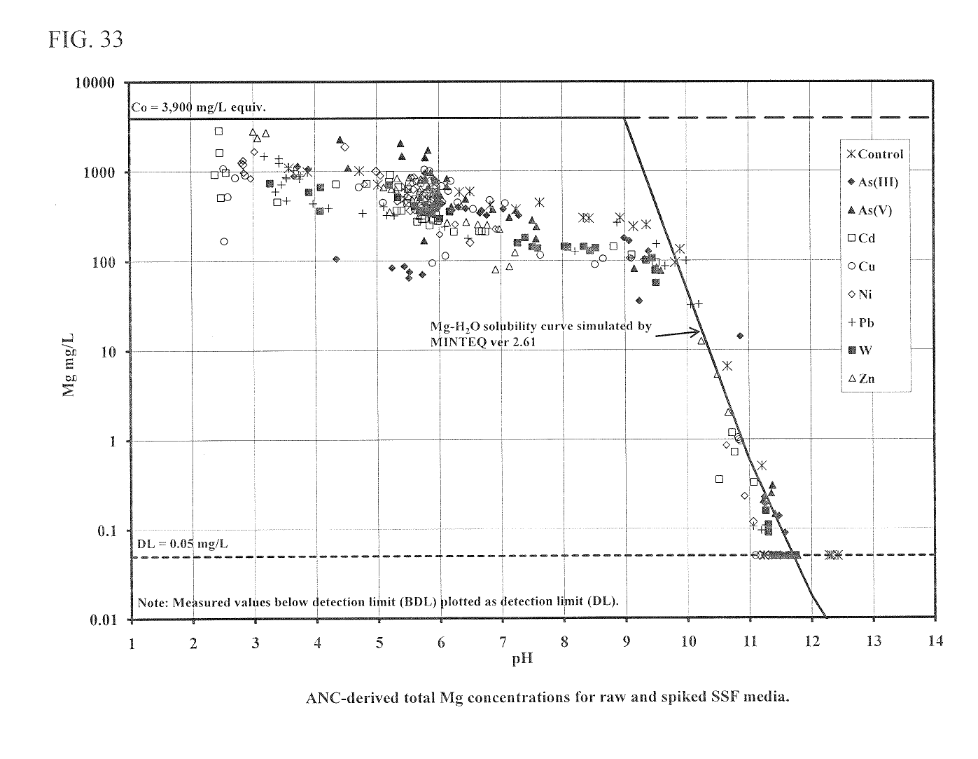

FIG. 31 shows the corresponding concentrations of Ca from the control and metals-spiked systems. The Ca concentration decreases with increasing pH, very likely due to the formation of calcite and insoluble arsenic and tungsten precipitates, as the oxyanions generally produce lower Ca concentrations as a function of pH. The concentration of iron (unspeciated) is significantly suppressed below the Fe(II) solubility line above pH 6 (FIG. 32), which partially reflects the presence of Fe(III) in the system. Nevertheless, above pH 7, Fe is essentially undetectable. The Mg trends (FIG. 33) mirror those of Ca, and apparent interactions with oxyanions produce the lowest Mg concentrations at each pH.

### Geothechnical Fill

In one embodiment, the metal immobilization media may include a mixture of slag fines directly blended with heavy metals laden soils and soil-like media (residues, dusts, powders, filter cakes, dredged material, fly ash or other ash materials, sludges, quarry fines, mine spoils etc.) to simultaneously provide geotechnical enhancements to the soft, weak, or wet soils and soil-like media (e.g., strength, reduced settlement) while immobilizing the heavy metals contained in the soils and soil-like media, and/or water present in pores of the soils and soil-like media, and/or in waters that may eventually pass through the combined media.

The mixture of slag fines and soil or soil-like media may be used in geotechnical fill applications, such as for example, general or bulk, embankment, and structural fill applications. The fill materials may be used in transportation, airport, building, and maritime construction; land reclamation; and brownfields and portfields redevelopment in urban areas. In order to qualify as an engineered fill, the compacted material must generally have a minimum compacted density greater than or equal to 90% relative compaction (RC) of the maximum dry density (MDD) attained by standard Proctor compaction (ASTM D698) up to a typical maximum of 95% RC of MDD attained by modified Proctor compaction (ASTM D1557).

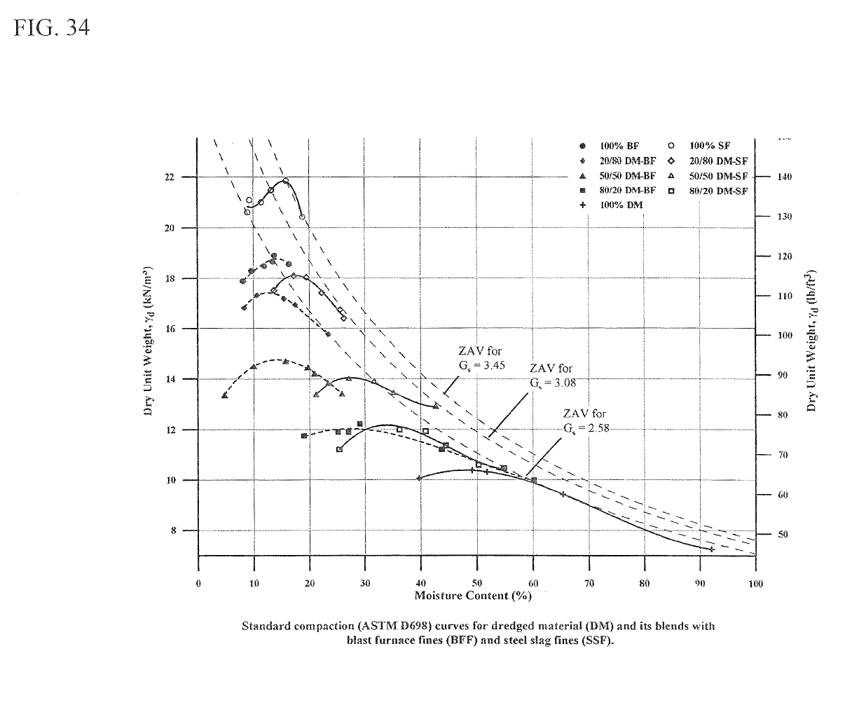

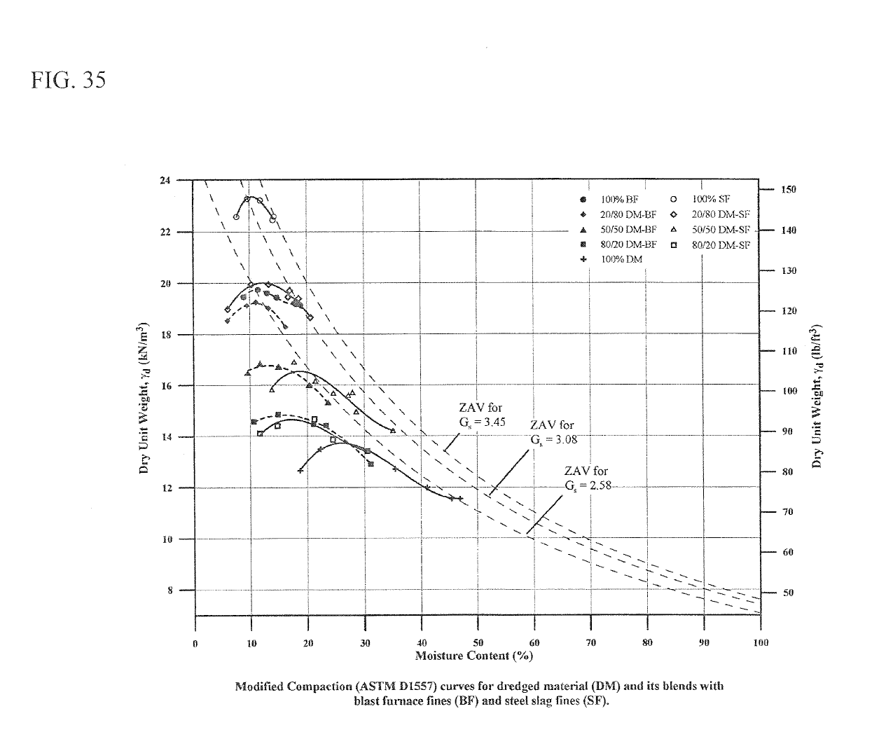

Compaction data for 100% DM, 100% SF, and 20/80, 50/50 and 80/20 DM-SF blends, separately using both SSF and BFF was also compiled to determine the unit weights of each mixture as fill material. FIGS. 34 and 35 show the Standard and Modified Proctor compaction data for the DM-SFF and DM-BFF blends, respectively.

### Example 6

In one example, slag fines may be mixed with soft soils or soil-like media (e.g., clays, loess, collapsible soils, quarry fines, mine spoil and other wet, soft media) to make engineered fills. Major benefits may be expected when blending slag fines with fresh DM, which is material removed from the bottom of a body of water and may include sediment, soil, silt, and clay. The slag fines may be SSF or BFF media. Partially de-watered DM, such as that having the bulk chemistry shown in FIG. 1, for example, stored in a dredged material containment facility may also be enhanced by removal and blending with slag fines. The DM may be taken from the containment facility and fed into a pugmill or other mixing device where it will be mixed with slag fines at prescribed ratios. The blended materials may be sampled and tested to determine that they satisfy prescribed mix ratios prior to use in fill construction.

A summary of the total concentrations (mg/kg) based on five replicates of the randomly sampled, SSF and BFF media and DM are shown in FIGS. 2, 3, and 5, respectively, for comparison purposes with the Maryland Voluntary Cleanup Program standards for residential and non-residential site uses (March 2008). As a general note, the last column in FIGS. 2, 3, and 5 in most cases show the numerical average of the measured concentrations for those replicates testing above the detection limit. The number of replicates used to develop the average is shown in parenthesis. In other cases, an “upper cap” on environmental quality was reasonably assigned, especially when the metals detection limit varied across the replicates, either showing all non-detects of different values (e.g., silver), or a combination of detection limits and values in non-critical cases (selenium).

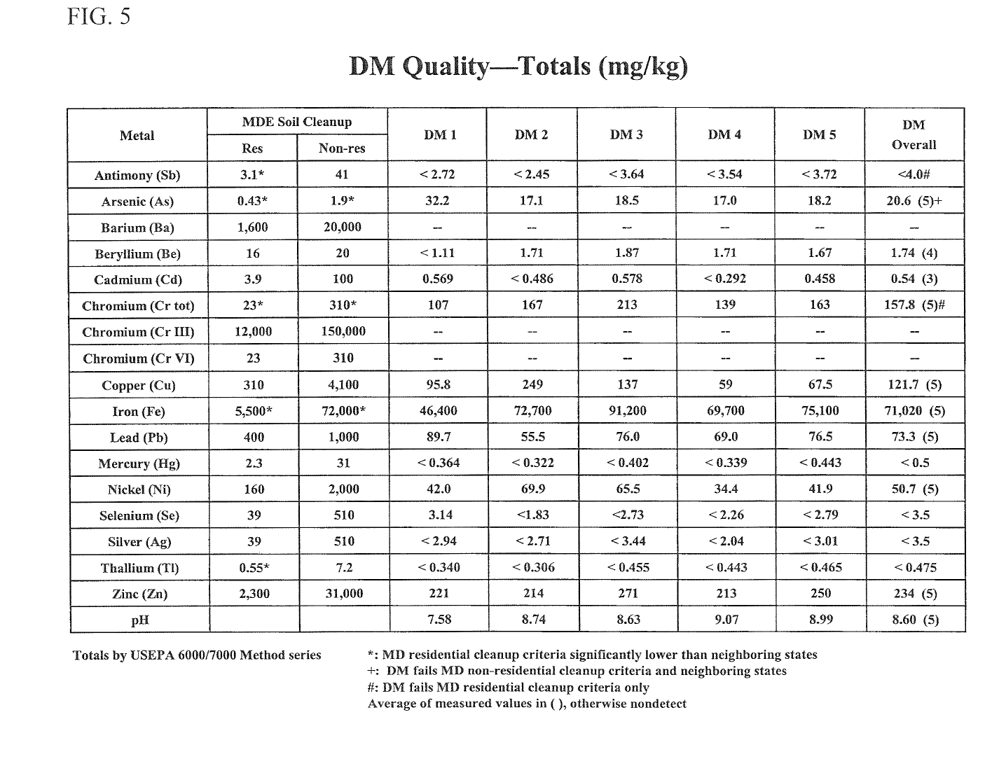

FIG. 5 summarizes the metals contents for the DM, which illustrates that the DM fails the residential criteria on four metals (antimony, chromium(tot), and iron) and non-residential criteria on arsenic. Antimony concentrations are slightly above residential, whereas the average iron concentrations are just under non-residential limits. Total chromium in its unspeciated form does not pass residential criteria, and the alkaline digestion process (USEPA 3060/7196 or 7199) was unsuccessful in speciating chrome in the DM on the basis of poor Cr(VI) spike recoveries and/or reactions occurring during the analytical procedure.

The SSF and BFF media pass MD residential criteria for everything except arsenic and iron. Arsenic is non-leachable, see below. Iron is a secondary water quality parameter, and its total concentration is not even regulated in neighboring states due to its non-hazardous nature. Chrome (1,100 mg/kg) was successfully spectated using the alkaline digestion process (USEPA 3060/7196 series) and were confirmed using X-ray absorption near edge spectroscopy (XANES), a new non destructive testing technique that has the ability to directly speciate and measure the concentrations of Cr(VI) and Cr(III) in the solid phase.

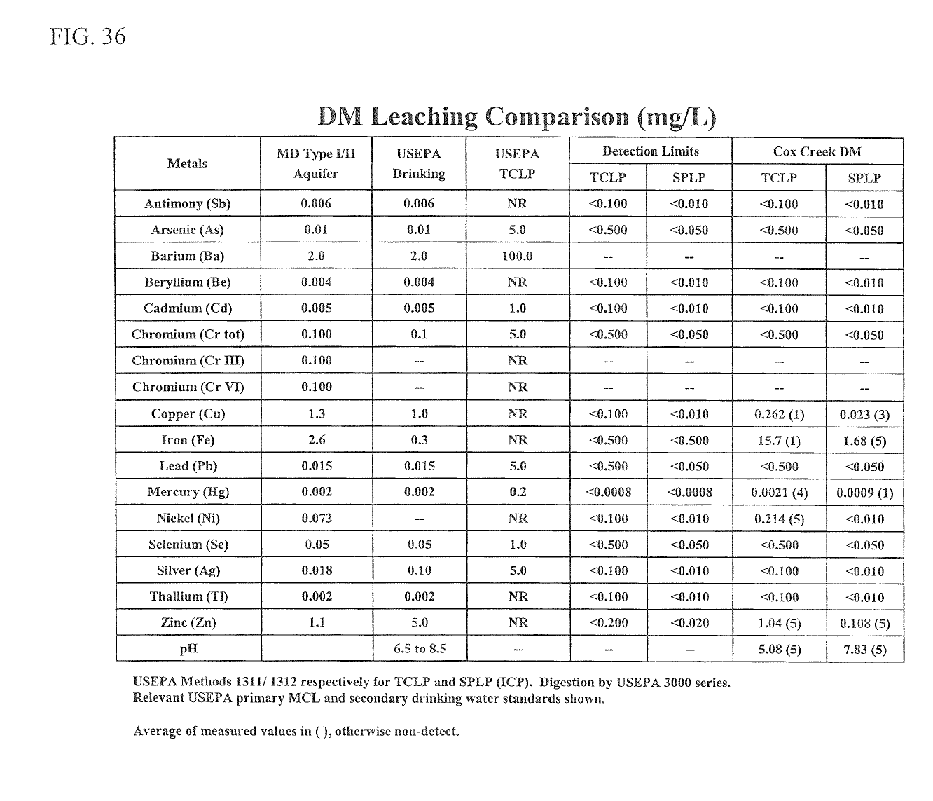

The TCLP and SPLP extractions were performed on the DM, the SSF and the BFF media. These results are summarized in FIGS. 36 and 37 and provide a direct comparison between regional groundwater quality standards and the TCLP and SPLP leaching behavior of the DM, SSF, and BFF media.

Excluding the individual hits on iron in both the DM and SSF which are significantly above the detection limits and appear to be outliers, only four metals (copper, mercury, nickel and zinc) were detected above their respective TCLP limits, all of them in the DM. Three metals (copper, mercury and zinc) were detected via SPLP in the DM, all below the MD Type HI aquifer criteria. Only zinc was detected in the SSF SPLP extract, which was likewise below the MD Type NI aquifer media. Additionally, despite the iron content of the SSF media of approximately 13.12 wt % (131,000 mg/kg), the SPLP leaching of iron was below the MD Type I/II aquifer criteria.

Based on the totals, TCLP and SPLP leaching behavior of the metals SFF and BFF media excess the environmental quality of the DM, making blending an attractive approach to recycle DM in large fill applications. The main purpose of this testing was to illustrate the ability of the SSF and BFF media to immobilize significant concentrations of arsenic occurring in the DM without additional additives and to set/propose an upper limit (totals) that could be tolerated based on understanding the arsenic leaching from the compacted dredged material-slag fines (DM-SF) blends. The main environmental motivation for blending slag fines with dredged material is that the geochemical characteristics of the slag fines (especially pH) are such that they have the ability to immobilize significant concentrations of arsenic (either As(III) or As(V)) in the DM.

### Example 7

In another example, DM naturally containing approximately 20 to 30 mg/kg As, was intentionally and individually spiked with 100 mg/kg As(III) or As(V) to evaluate how successful the SSF and BFF media would be in immobilizing As. In this way, the DM acted as the source of As contamination. Immobilization of arsenic was tested using 100% DM, 100% SF, and 20/80, 50/50 and 80/20 DM-SF blends, using both SSF and BFF media. Sodium arsenite (NaAsO₂) and sodium arsenate heptahydrate (Na₂HAsO₄.7H₂O) were used as the As(III) and As(V) sources, respectively (ACS grade, Fisher Scientific, GA). The DM was spiked separately with 100 mg/kg (dry weight basis) of As(III) and As(V). Aqueous solutions of each arsenic salt were prepared using deionized water and were targeted to achieve final bucket moisture content on the order of 130 to 135%. This allowed the raw DM to have a liquid consistency sufficient to enable its homogenization with the much drier, granular SSF and BFF media.

Raw DM was placed in a Globe SP-30 mixer (Dayton, Ohio) and was homogenized as-is for approximately 10 minutes. Thereafter, during mixing, the arsenic solution was gradually introduced to the DM using a series of polyethylene squirt bottles. Mixing was paused every 10 minutes to manually scrape the excess DM off of the bucket sidewalls using a spatula. This material was blended by hand for some moments, and then the automated mixing bucket was restarted until a total of 40 minutes elapsed. The DM was then removed and the device was cleaned prior to mixing the next batch. Individual batches of As-spiked DM were stored in sealable 5-gallon bucket for a mellowing period of 30 days to enable equilibration.

In the DM-SF blends (where SF=SSF or BFF), the As source was always the DM. However, the SSF and BFF media were spiked with As to explicitly evaluate its ability to immobilize As as a raw material. The spiking procedure for the SSF and BFF media involved As(III) and As(V) concentrations of 100 mg/kg and is described above. The As spiked SSF and BFF media were then stored in 1 gallon sealable plastic bags and allowed to mellow for 30 days.

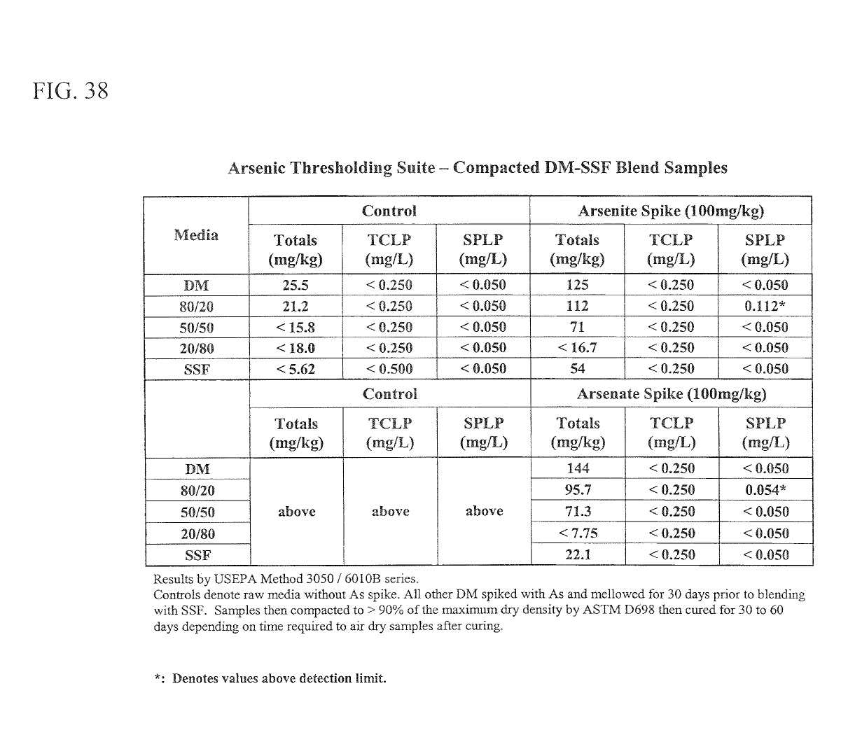

The thresholding suite consisted of the DM, SF and the 20/80, 50/50 and 80/20 DM-SF blends (dry weight percent of DM reported first for the blends). These samples were blended immediately following the mellowing period of DM. Upon homogenization, they were compacted to greater than 90% of the maximum dry density by Standard Proctor compaction (ASTM D698), removed from the molds then cured in sealable plastic bags for an additional 30 days. FIG. 38 shows the results of As(III) and As(V) TCLP and SPLP leaching results from the compacted samples, respectively.

### Example 8

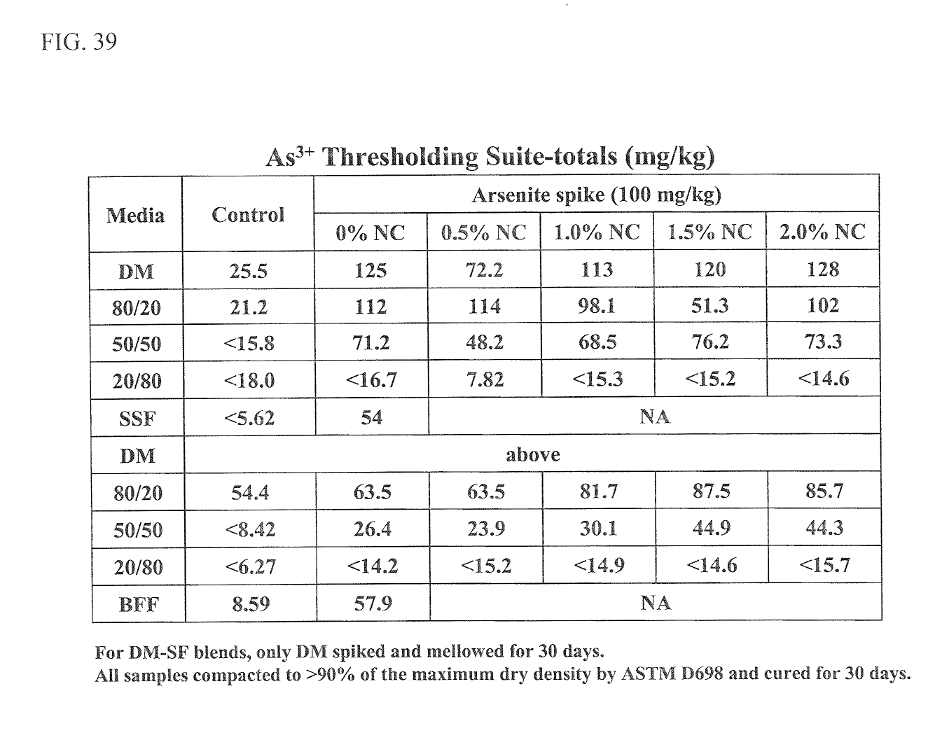

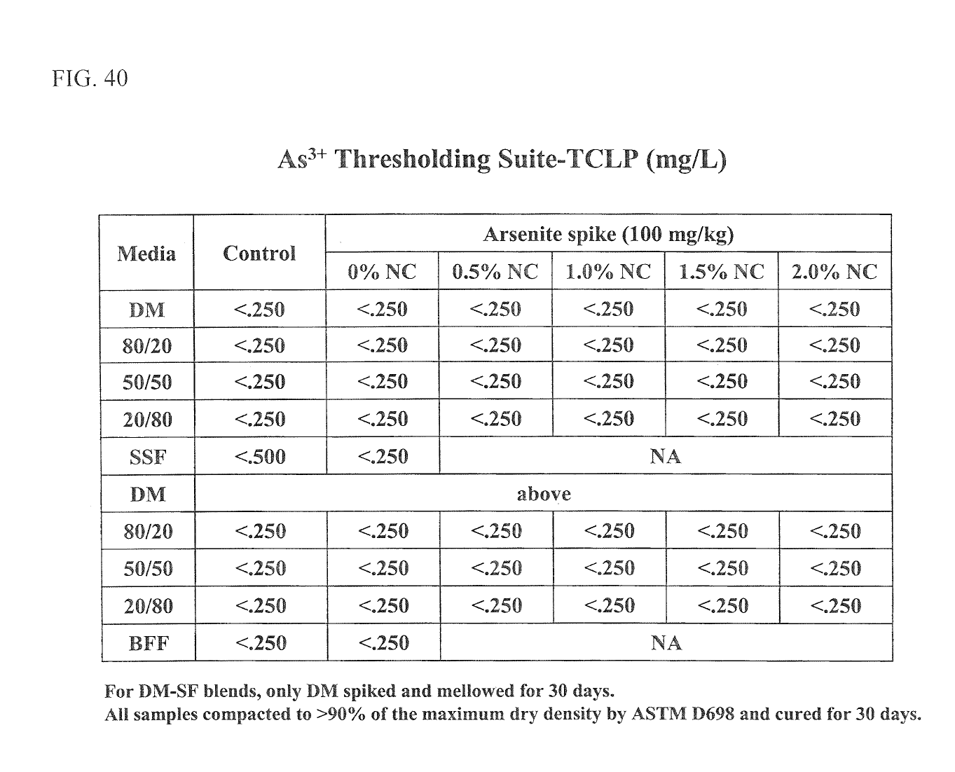

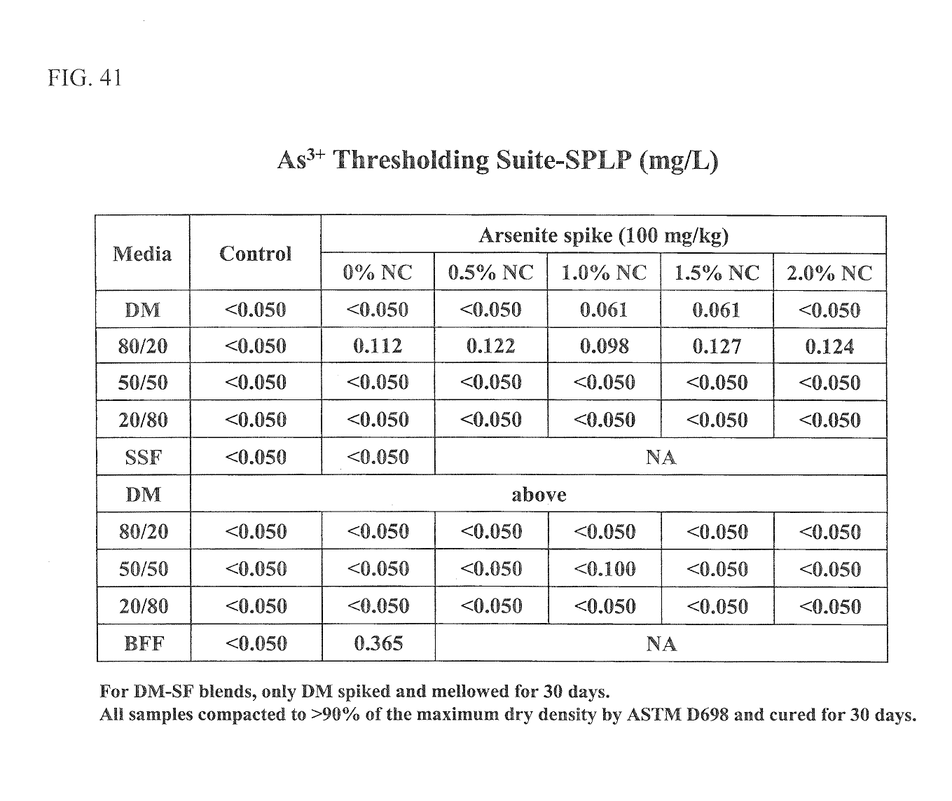

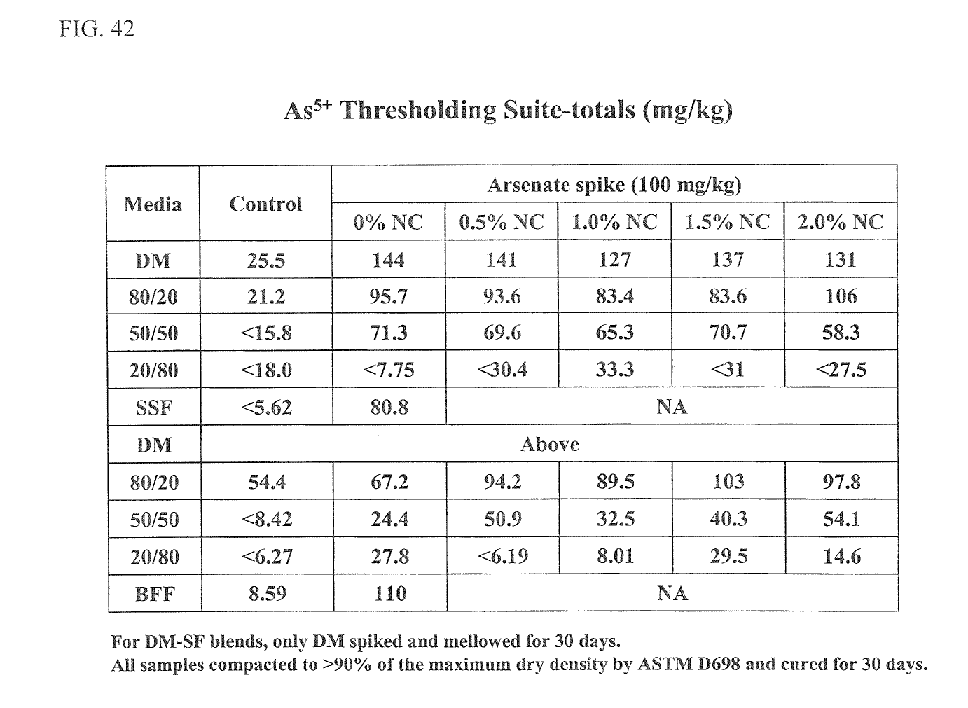

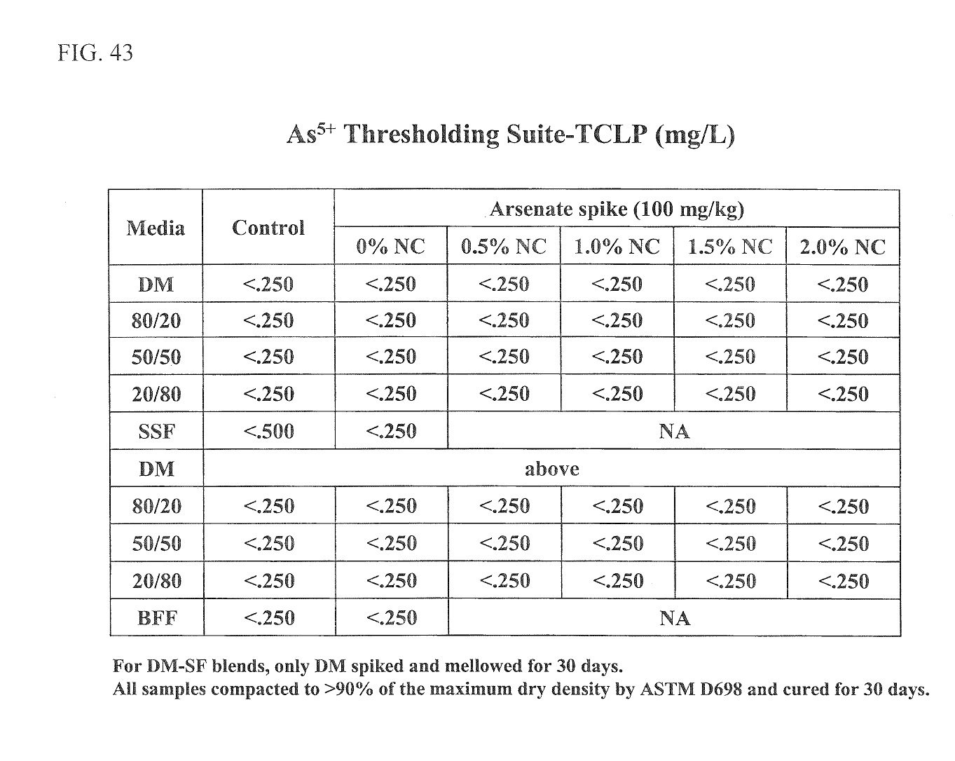

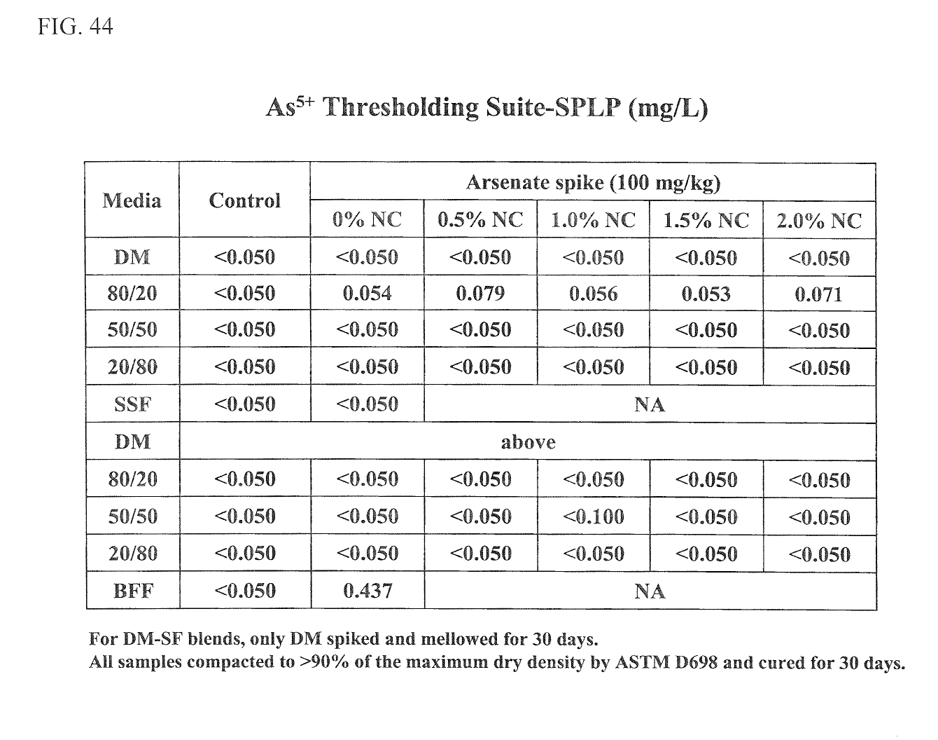

In another example, the mixtures of Example 4 (100% DM, 100% SF, and 20/80, 50/50 and 80/20 DM-SF blends, using both SSF and BFF media) were tested with the addition of 0% NewCem (NC) or slag cement, 0.5% NC, 1.0% NC, 1.5% NC, and 2.0% NC. The results are shown in FIGS. 39-41 for As(III) and FIGS. 42-44 for As(V) and generally indicated that adding cement as an additional stabilizing agent is not necessary.

### Example 9

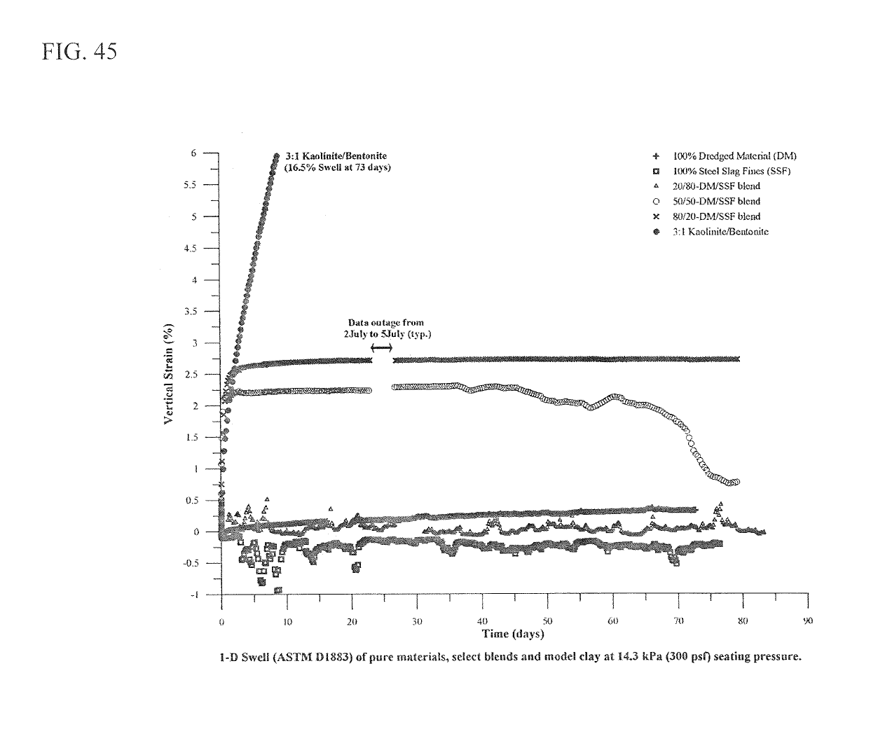

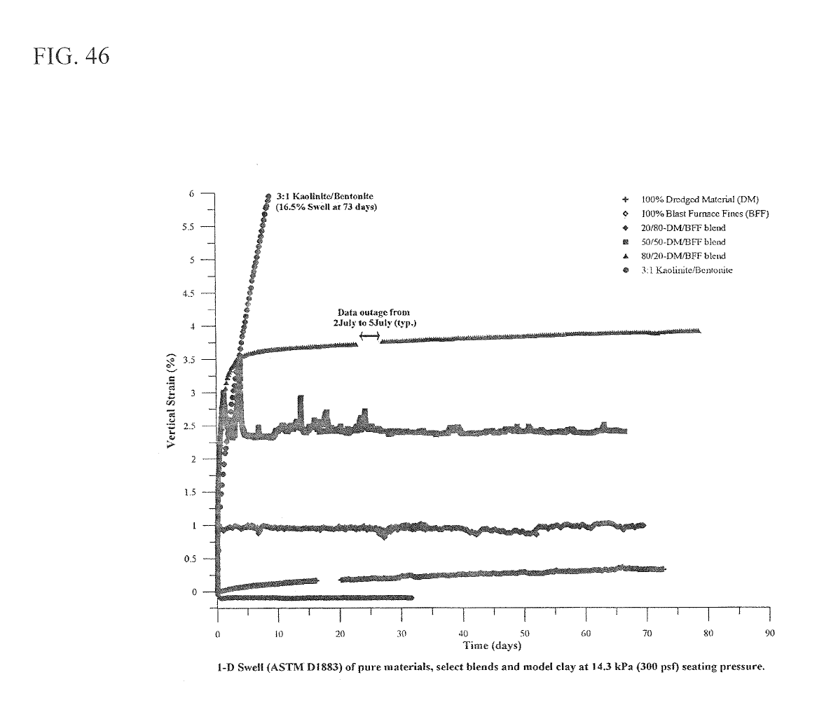

Swell data was obtained for 100% DM, 100% SF, and 20/80, 50/50 and 80/20 DM-SF blends, using both SSF and BFF media using the same sample preparation process described in Example 7. This data was compared to the swell behavior of reference of 3:1 kaolinite-bentonite clay blend. FIG. 45 shows the swell behavior for the SSF blends attained using ASTM D1833. FIG. 46 shows the swell behavior for the BFF blends attained using ASTM D1833.

As can be shown From the above data and examples, the SSF and BFF media illustrate unexpected results in stabilizing DM to immobilize oxyanionic metals, particularly arsenic. Blending the SSF and/or BFF media with soils or soil-like media contaminated with arsenic may be a successful way of immobilizing the arsenic therein. In addition, the combination of DM and slag fines may harden over time enhancing its usefulness as a fill material. It is believed that the lime present in the slag fines may be a contributing factor in the immobilization properties of the slag fines. In addition, the slag fines, particularly the SSF media, exhibit strong pH control and buffering capacity. This may enable the structures and fills formed from slag fines and DM-SF blends to also act as a filtering medium for contaminated water that passes through the structures or fills.

As discussed above, slag fines have many beneficial uses in metals immobilization. For example, slag fines may be used alone or in combination with other materials as a metals immobilization media for using in firing ranges as a backstop berm, as a filtering medium, and as a geotechnical fill material.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A method for immobilizing heavy metals in soil, comprising:
blending slag fines with soil to form a media, wherein the slag fines contain Fe(0), are geochemically active, immobilize metal present in the media, and reduce leaching of the metal into water.

2. The method of claim 1, wherein the slag fines are steel slag fines, blast furnace slag fines, or combinations thereof.

3. The method of claim 1, wherein the slag fines are bordered by, enclosed by, layered with, or prefabricated with a geosynthetic.

4. The method of claim 1, wherein the metal immobilized by the slag fines is a cationic metal, an oxyanionic metal, or alloys thereof.

5. The method of claim 4, wherein the cationic metal is selected from the group consisting of cadmium, copper, lead, nickel, zinc, and alloys thereof.

6. The method of claim 4, wherein the oxyanionic metal is selected from the group consisting of arsenic, phosphorus, selenium, tungsten, uranium, and alloys thereof.

7. The method of claim 1, wherein the metal immobilized by the slag fines is selected from the group consisting of lead, copper, cadmium, zinc, arsenic, selenium, tungsten, uranium, nickel, phosphorus, and alloys thereof.

8. The method of claim 1, wherein the slag fines immobilize the metal through a process selected from the group consisting of sorption, precipitation, complexation, pH controlled processes, oxidation and reduction processes, and combinations thereof.

9. The method of claim 1, wherein the soil comprises soil-like media.

10. The method of claim 9, wherein the soil-like media is selected from the group consisting of residue, dust, powder, filter cake, dredged material, ash materials, sludge, quarry fines, mine spoil, and combinations thereof.

11. The method of claim 1, further comprising making a berm or berm system for a firing range comprising the media.

12. The method of claim 11, wherein the metal is lead, copper, cadmium, zinc, arsenic, selenium, tungsten, uranium, nickel, phosphorus, or alloys thereof.

13. The method of claim 1, further comprising applying ground covering at a firing range with the media.

14. The method of claim 13, wherein the metal is lead, copper, cadmium, zinc, arsenic, selenium, tungsten, uranium, nickel, phosphorus, or alloys thereof.

15. The method of claim 1, further comprising making a geotechnical fill comprising the media.

16. The method of claim 15, wherein the metal is arsenic or alloys thereof.

17. The method of claim 15, wherein the geotechnical fill is usable for applications selected from the group consisting of earthwork construction, land reclamation, mine reclamation, brownfields redevelopment, and portfields redevelopment.

18. Metal immobilization media comprising:
a blend of slag fines and soil, wherein the slag fines contain Fe(0), are geochemically active, immobilize a metal present in the media, and reduce leaching of the metal into water.

19. The media of claim 18, wherein the slag fines are steel slag fines, blast furnace slag fines or combinations thereof.

20. The media of claim 18, wherein the slag fines are bordered by, enclosed by, layered with, or prefabricated with a geosynthetic.

21. The media of claim 18, wherein the slag fines are capable of immobilizing a cationic metal, an oxyanionic metal, or alloys thereof.

22. The media of claim 21, wherein the cationic metal is selected from the group consisting of cadmium, copper, lead, nickel, zinc, and alloys thereof.

23. The media of claim 21, wherein the oxyanionic metal is selected from the group consisting of arsenic, phosphorus, selenium, tungsten, uranium, and alloys thereof.

24. The media of claim 18, wherein the slag fines are capable of immobilizing metal selected from the group consisting of lead, copper, cadmium, zinc, arsenic, selenium, tungsten, uranium, nickel, phosphorus and alloys thereof.

25. The media of claim 18, wherein the soil comprises soil-like media.

26. The media of claim 25, wherein the soil-like media is selected from the group consisting of residue, dust, powder, filter cake, dredged material, ash material, sludge, quarry fines, mine spoil, and combinations thereof.

27. The media of claim 18, wherein the media is a berm for a firing range.

28. The media of claim 27, wherein the slag fines are capable of immobilizing lead, copper, cadmium, zinc, arsenic, selenium, tungsten, uranium, nickel, phosphorus, or alloys thereof.

29. The media of claim 18, wherein the media is ground covering at a firing range.

30. The media of claim 29, wherein the slag fines are capable of immobilizing lead, copper, cadmium, zinc, arsenic, selenium, tungsten, uranium, nickel, phosphorus, or alloys thereof.

31. The media of claim 18, wherein the media is a geotechnical fill.

32. The media of claim 31, wherein the slag fines are capable of immobilizing arsenic or alloys thereof.

33. The media of claim 31, wherein the geotechnical fill is capable for use in applications selected from the group consisting of earthwork construction, land reclamation, mine reclamation, brownfields redevelopment, and portfields redevelopment.

34. A method of filtering water, comprising: placing a filter comprising a blend of slag fines in a flow path of water, wherein the slag fines immobilize a metal present in the water to reduce an aqueous phase concentration of the metal in the water and the slag fines are geochemically active and contain Fe(0).

35. The method of claim 34, wherein the slag fines are steel slag fines, blast furnace slag fines or combinations thereof.

36. The method of claim 34, wherein the slag fines are bordered by, enclosed by, layered with, or prefabricated with a geosynthetic.

37. The method of claim 34, wherein the metal immobilized by the slag fines is a cationic metals, an oxyanionic metal, or alloys thereof.

38. The method of claim 37, wherein the cationic metal is selected from the group consisting of cadmium, copper, lead, nickel, zinc, and alloys thereof.

39. The method of claim 37, wherein the oxyanionic metal is selected from the group consisting of arsenic, phosphorus, selenium, tungsten, uranium, and alloys thereof.

40. The method of claim 34, wherein the metal immobilized by the slag fines is selected from the group consisting of lead, copper, cadmium, zinc, arsenic, selenium, tungsten, uranium, nickel, phosphorus, and alloys thereof.

41. The method of claim 34, wherein the metal is arsenic.

42. A metal immobilization filter, comprising:
a blend of slag fines, wherein the slag fines are capable of immobilizing a metal present in a water passing through the filter to reduce an aqueous phase concentration of the metal in the water and the slag fines are geochemically active and contain Fe(0).

43. The filter of claim 42, wherein the slag fines are steel slag fines, blast furnace slag fines, or combinations thereof.

44. The filter of claim 42, further comprising a geotextile bordering, enclosing, layered with, or prefabricated with a layer of the slag fines

45. The filter of claim 42, wherein the slag fines are capable of immobilizing a cationic metal, an oxyanionic metal, or alloys thereof.

46. The filter of claim 45, wherein the cationic metal is selected from the group consisting of cadmium, copper, lead, nickel, zinc, and alloys thereof.

47. The filter of claim 45, wherein the oxyanionic metal is selected from the group consisting of arsenic, phosphorus, selenium, tungsten, uranium, and alloys thereof.

48. The filter of claim 42, wherein the slag fines are capable of immobilizing metal selected from the group consisting of lead, copper, cadmium, zinc, arsenic, selenium, tungsten, uranium, nickel, phosphorus, and alloys thereof.
